(19) United States
(12) Patent Application Publication
(10) Pub. No.: US 2025/0319393 A1
(43) Pub. Date: Oct. 16, 2025

(54) CROSSHAIR CONTROL METHOD AND APPARATUS, COMPUTER DEVICE, AND STORAGE MEDIUM

(71) Applicant: Tencent Technology (Shenzhen) Company Limited, Shenzhen (CN)

(72) Inventors: Chuyuan GUO, Shenzhen (CN); Ruoyu ZHAO, Shenzhen (CN); Ziteng WANG, Shenzhen (CN); Haoqiang CHEN, Shenzhen (CN)

(21) Appl. No.: 19/250,008

(22) Filed: Jun. 25, 2025

Related U.S. Application Data
(63) Continuation of application No. PCT/CN2024/083469, filed on Mar. 25, 2024.

(30) Foreign Application Priority Data
May 15, 2023 (CN) 202310545776.0

(51) Int. Cl. A63F 13/426; A63F 13/53; A63F 13/837

(52) U.S. Cl. CPC A63F 13/426; A63F 13/53; A63F 13/837

(57) ABSTRACT

Embodiments of this application disclose a crosshair control method performed by a computer device. The computer device displays a first virtual object and a crosshair on a scene interface of a virtual environment. When the crosshair is located outside an attraction range of the first virtual object, the computer device determines a first moving direction of the crosshair in response to a first moving operation on the crosshair by a user of the computer device. The computer device determines a first attraction point on the first virtual object based on a motion posture of the first virtual object in response to the crosshair being located within the attraction range and the first moving direction pointing to the first virtual object. The computer device moves the crosshair toward the first attraction point on the scene interface.

### CROSS-REFERENCE TO RELATED APPLICATIONS

This application is a continuation application of PCT Patent Application No. PCT/CN2024/083469, entitled “CROSSHAIR CONTROL METHOD AND APPARATUS, COMPUTER DEVICE, AND STORAGE MEDIUM” filed on Mar. 25, 2024, which claims priority to Chinese Patent Application No. 2023105457760, entitled “CROSSHAIR CONTROL METHOD AND APPARATUS, COMPUTER DEVICE, AND STORAGE MEDIUM” filed on May 15, 2023, both of which are incorporated herein by reference in their entirety.

### FIELD OF THE TECHNOLOGY

Embodiments of this application relate to the field of computer technologies, and in particular, to a crosshair control method and apparatus, a computer device, and a storage medium.

### BACKGROUND OF THE DISCLOSURE

With development of computer technologies, types of games become increasingly abundant and diversified. In a current battle game, a crosshair is usually displayed on a scene interface of a virtual environment, so that a user can aim at a virtual object in the virtual environment based on the displayed crosshair and then interact with the aimed-at virtual object. However, in a process of adjusting, by the user, the crosshair to aim at the virtual object, the user needs to repeatedly perform adjustment, and adjustment efficiency is low.

### SUMMARY

Embodiments of this application provide a crosshair control method and apparatus, a computer device, and a storage medium.

According to an aspect, a crosshair control method is performed by a computer device. The method includes:
displaying a first virtual object and a crosshair on a scene interface of a virtual environment;
when the crosshair is located outside an attraction range of the first virtual object, determining a first moving direction of the crosshair in response to a first moving operation on the crosshair by a user of the computer device;
determining a first attraction point on the first virtual object based on a motion posture of the first virtual object when the crosshair is located within the attraction range of the first virtual object and the first moving direction points to the first virtual object; and
moving the crosshair toward the first attraction point on the scene interface.

According to another aspect, a computer device is provided. The computer device includes a processor and a memory. The memory has at least one computer program stored therein. The at least one computer program is loaded and executed by the processor to cause the computer device to implement the crosshair control method in the foregoing aspects.

According to another aspect, a non-transitory computer-readable storage medium has at least one computer program stored therein. The at least one computer program is loaded and executed by a processor of a computer device to cause the computer device to implement the crosshair control method in the foregoing aspects.

Details of one or more embodiments of this application are provided in the accompanying drawings and descriptions below. Other features and advantages of this application become clear with reference to the specification, the accompanying drawings, and the claims.

### BRIEF DESCRIPTION OF THE DRAWINGS

To describe the technical solutions in the embodiments of this application more clearly, the following briefly describes the accompanying drawings required for describing the embodiments. Clearly, the accompanying drawings in the following description show only some embodiments of this application, and a person of ordinary skill in the art may still derive other drawings from these accompanying drawings without creative efforts.

FIG. 1 is a schematic diagram of a structure of an implementation environment according to an embodiment of this application.

FIG. 2 is a flowchart of a crosshair control method according to an embodiment of this application.

FIG. 3 is a flowchart of another crosshair control method according to an embodiment of this application.

FIG. 4 is a schematic diagram of an attraction range and an auxiliary aiming line according to an embodiment of this application.

FIG. 5 is a schematic diagram of another attraction range and auxiliary aiming line according to an embodiment of this application.

FIG. 6 is a schematic diagram of another attraction range and auxiliary aiming line according to an embodiment of this application.

FIG. 7 is a schematic diagram of another attraction range and auxiliary aiming line according to an embodiment of this application.

FIG. 8 is a schematic diagram of another attraction range and auxiliary aiming line according to an embodiment of this application.

FIG. 9 is a schematic diagram of a crosshair moving toward a first virtual object according to an embodiment of this application.

FIG. 10 is a flowchart of another crosshair control method according to an embodiment of this application.

FIG. 11 is a flowchart of another crosshair control method according to an embodiment of this application.

FIG. 12 is a flowchart of another crosshair control method according to an embodiment of this application.

FIG. 13 is a schematic diagram of a structure of a crosshair control apparatus according to an embodiment of this application.

FIG. 14 is a schematic diagram of a structure of another crosshair control apparatus according to an embodiment of this application.

FIG. 15 is a schematic diagram of a structure of a terminal according to an embodiment of this application.

FIG. 16 is a schematic diagram of a structure of a server according to an embodiment of this application.

### DESCRIPTION OF EMBODIMENTS

The technical solutions in the embodiments of this application are clearly and thoroughly described in the following with reference to the accompanying drawings in the embodiments of this application. Clearly, the described embodiments are merely some rather than all of the embodiments of this application. All other embodiments obtained by a person of ordinary skill in the art based on the embodiments of this application without creative efforts shall fall within the protection scope of this application.

The terms “first”, “second”, “third”, “fourth”, and the like used in this application may be configured for describing various concepts in this specification. However, unless otherwise specified, the concepts are not limited by the terms. The terms are merely configured for distinguishing one concept from another concept. For example, without departing from the scope of this application, a first moving speed may be referred to as a second moving speed, and similarly, a second moving speed may be referred to as a first moving speed.

Among the terms “at least one”, “a plurality of”, “each”, and “anyone” used in this application, “at least one” includes one, two, or more, “a plurality of” includes two or more, “each” indicates each of a plurality of corresponding items, and “anyone” indicates any one of a plurality of items. For example, a plurality of virtual objects include three virtual objects, “each” indicates each of the three virtual objects, and “anyone” indicates any one of the three virtual objects, which may be the first virtual object, the second virtual object, or the third virtual object.

For ease of understanding the embodiments of this application, some terms in the embodiments of this application are first described.

Virtual environment: It is a virtual environment displayed (or provided) by an application when the application is run on a terminal, in other words, a scene displayed when a game is run on the terminal. For example, the game is a shooting game, and the virtual environment is a scene displayed when the game is run on the terminal. The virtual environment is a simulated environment of a real world, a semi-simulated semi-fictional virtual environment, or a purely fictional virtual environment. The virtual environment is any one of a two-dimensional virtual environment, a 2.5-dimensional virtual environment, or a three-dimensional virtual environment. This is not limited in this application. For example, the virtual environment includes the sky, the land, or the ocean. The land includes environmental elements such as the desert and a city. A user can control a virtual object to move in the virtual environment. Certainly, the virtual environment further includes a virtual item, for example, a virtual thrown object, a virtual building, or a virtual machine. The virtual environment can be further configured for simulating real environments in different weather, for example, a sunny day, a rainy day, a foggy day, or a night. Various scene elements enhance diversity and realness of the virtual environment. For example, the virtual environment is an open virtual world provided by a game. The open virtual world indicates that a virtual environment in the game is completely free and open. A player can control a virtual object to freely move forward in any direction for exploration, and a distance between boundaries in different directions is quite large. In addition, the virtual environment also includes virtual items of various shapes and sizes, which can physically collide or interact with entities, such as a virtual object or an artificial intelligence (AI) object, controlled by the player.

Virtual object: It is a movable virtual character in a virtual environment. The movable object is a virtual person, a virtual animal, a cartoon person, or the like. The virtual object is a virtual image configured for representing a user in the virtual environment. The virtual environment includes a plurality of virtual objects, and each virtual object has a shape and a volume in the virtual environment, and occupies some space in the virtual environment. The virtual object can perform activities such as crawling, walking, running, jumping, driving, picking, shooting, attacking, and throwing in the virtual environment. In some embodiments, the virtual object is a character controlled through an operation on a client, an AI object configured in a virtual environment through training, or a non-player character (NPC) configured in the virtual environment. In some embodiments, the virtual object is a virtual person competing in the virtual environment.

Virtual item: It is an item that can be used by a virtual object in a virtual environment. For example, the virtual item may be a shooting item or a virtual vehicle. In a virtual environment, a virtual object can interact with another virtual object by using a virtual item.

First-person shooting (FPS) game: The FPS game is a branch of an action (ACT) game. However, like a real-time strategy (RTS) game, the FPS game develops into a separate type due to its rapid popularity throughout the world. The FPS game is a shooting game that a user can play from a first-person perspective (namely, a subjective perspective of a player). A picture of a virtual environment in the game is a picture of observing the virtual environment from a perspective of a virtual object controlled by a terminal. In the FPS game, a user no longer controls a virtual object on a screen to play the game like in another game, but experiences, in an immersive manner, visual impact brought by the game. This greatly enhances initiative and a sense of reality of the game. Usually, the FPS game provides more abundant stories, beautiful pictures, and vivid sound effects.

Aiming down sight (ADS) device: It is an observation device usually made of metal, and is configured to position a virtual item and an aiming target on a same straight line when no aiming sight is equipped, to help the virtual item aim at a specific aiming target. In this case, an angle of a camera moves to the rear of an aiming sight of the virtual item, so that the virtual item can perform precise aiming, and a specific zoom ratio can be further provided, to provide higher availability within a farther range. When an aiming sight is equipped, a scale or a specially designed aiming line is usually provided, to magnify an image of an aiming target on a retina, so that aiming becomes easier and more precise. A magnification ratio is directly proportional to an objective lens diameter of the aiming sight. A larger objective lens diameter can make the image clearer and brighter, but a field of view (FOV) may be narrowed at high magnification.

Hip firing: It is a shooting mode of shooting without aiming down the sight in a shooting game. Shooting without aiming down the sight is a primitive aiming mode. Because a virtual object shoots without aiming down the sight, during hip firing, a crosshair of shooting usually has low accuracy, and a deviation or shaking is likely to occur.

Crosshair: It is located at a center of an FOV range in an FPS game. The crosshair indicates an interaction position at which a virtual object performs interaction. For example, when the virtual object holds a shooting item, the crosshair indicates a landing point of a virtual bullet fired by the virtual object by using the shooting item. In an FPS game that tends to be playful rather than realistic, the crosshair is located at a center of a screen to assist in aiming of a shooting item, and represents a flight direction of an item launched by the shooting item.

FOV: The FOV is a field of view of a virtual camera in a virtual environment, and is measured in degrees. The FOV is also an angle range within which the virtual camera can receive an image in the virtual environment. In a first-person perspective game, a user observes a virtual environment from a first-person perspective. Therefore, in the first-person perspective game, an FOV of a virtual object controlled by a terminal is a picture displayed on a scene interface, namely, a picture displayed by the user on a terminal screen. The displayed picture represents an FOV range within which the virtual object controlled by the terminal can observe a game world.

Mesh: It is a collection of vertexes and polygons that represent a polyhedral shape in three-dimensional computer graphics. The mesh is usually formed by a triangle or a simple convex polygon.

Breathing animation: It simulates an animation state in which a player does not perform any other behavior when holding a shooting item, and can present a slight swing of a hand of a virtual object.

Firing animation: It is an animation displayed along with firing by a shooting item in a shooting game. For example, the firing animation is configured for presenting a motion status of a virtual part of a shooting item along with firing by the shooting item, and relates to a back-and-forth action of the shooting item, an action of a charging handle of the shooting item moving along with a bolt, a back-and-forth action of a slide of the shooting item, an action of a movable part of the shooting item, and the like, to enhance a sense of reality and a sense of immersion of firing.

Recoil: It is an action force pushing a shooting item backward when the shooting item launches any item. For example, when the shooting item fires a virtual bullet, gunpowder gas also applies pressure to the virtual bullet, to push the shooting item backward to generate a recoil. Usually, a larger caliber of the shooting item indicates a stronger recoil when the shooting item fires a virtual bullet.

Character animation: It is an animation configured for representing an action of a virtual object holding a shooting item in a shooting game upon firing by the shooting item. For example, the character animation relates to an action of the virtual object subject to a recoil of the shooting item in a vertical direction and a horizontal direction. The action includes, but is not limited to, swinging of an upper body part of the virtual object, an accompanying motion of lower limbs, vibration of arms, a head motion, a facial expression, and the like, to vividly show the power of firing and shooting by the shooting item, and enhance a sense of reality and a sense of immersion of the shooting game.

Auxiliary aiming: In an FPS game, an auxiliary aiming function may be added when operations are performed without a keyboard or a mouse. Compared with a case in which a shooting game is played by using a keyboard and a mouse, when an operation is performed on a mobile device by using a handle and a touchscreen, an operation requirement is usually high, operation difficulty is high, and a user may not be accustomed to an operation mode on the mobile device. The auxiliary aiming function is added to help the user smoothly perform game operations on the mobile device. In terms of demonstration, rotation of a virtual camera is controlled to help a crosshair to automatically aim at a target within a field of view. The auxiliary aiming function can be triggered when the crosshair is located within an attraction range of the target, and the crosshair is controlled by the auxiliary aiming function to automatically point to the target to be aimed at and temporarily follow the target.

Skeleton socket: It is a socket mounted on a skeleton of an object model of a virtual object. Relative positions of the skeleton socket and the model skeleton remains unchanged, and the skeleton socket moves along with the model skeleton.

All data (including but not limited to game data, a first correspondence, a second correspondence, and the like) in this application is authorized by a user or fully authorized by all parties, and collection, use, and processing of related data need to comply with related laws, regulations, and standards in related countries and regions. For example, all game data in this application is obtained with full authorization.

A crosshair control method provided in the embodiments of this application can be performed by a computer device. In some embodiments, the computer device is a terminal or a server. In some embodiments, the server is an independent physical server, a server cluster or a distributed system that includes a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. In some embodiments, the terminal is a smartphone, a tablet computer, a notebook computer, a desktop computer, a smart speaker, a smartwatch, a smart voice interaction device, a smart home appliance, an in-vehicle terminal, or the like, but is not limited thereto.

In some embodiments, a computer program in the embodiments of this application may be deployed on one computer device for execution, or may be executed on a plurality of computer devices at one location, or may be executed on a plurality of computer devices that are distributed at a plurality of locations and that are interconnected through a communication network. The plurality of computer devices that are distributed at a plurality of locations and that are interconnected through a communication network can form a blockchain system.

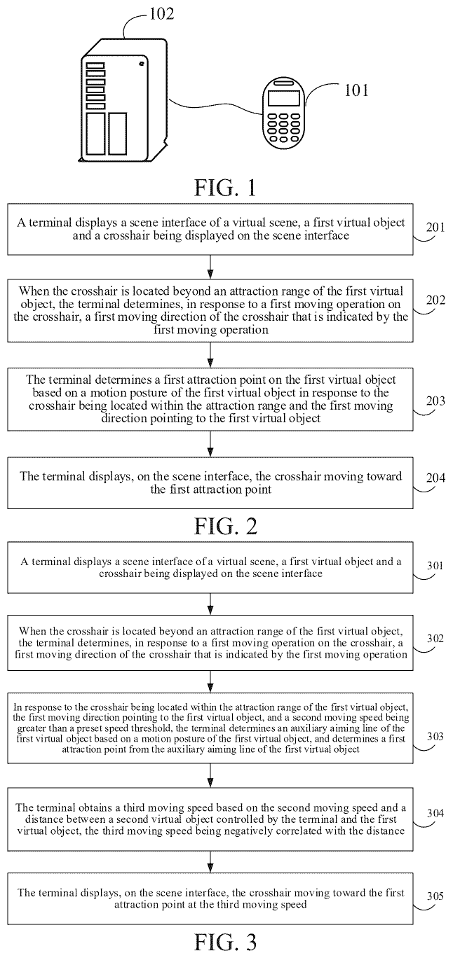

In some embodiments, the crosshair control method is performed by a terminal. FIG. 1 is a schematic diagram of an implementation environment according to an embodiment of this application. As shown in FIG. 1, the implementation environment includes a terminal 101 and a server 102. The terminal 101 and the server 102 are connected to each other through a wired or wireless network.

An application for which the server 102 provides a service is installed on the terminal 101. The application supports display of a scene interface of a virtual environment. The terminal 101 can implement functions such as a game and message exchange by using the application. In some embodiments, the application is an application in an operating system of the terminal 101, or an application provided by a third party. For example, the application is a game application, and the game application has a game function. Certainly, the game application can further have other functions such as a shopping function, a navigation function, and a message exchange function. The terminal 101 is a terminal used by any user. The user can control, by using the terminal 101, a virtual object in the virtual environment to perform an activity. The activity includes, but is not limited to, at least one of crawling, walking, running, jumping, driving, picking, shooting, attacking, and throwing. In some embodiments, different users respectively use different terminals to control virtual objects, and the virtual objects controlled by the different terminals are located in the same virtual environment. In this case, the different virtual objects can perform activities.

The terminal 101 is configured to log in to the application based on a user identity, and interact with the server 102 through the application, to display the scene interface of the virtual environment, and display a crosshair on the scene interface. The crosshair can be controlled, through a moving operation on the crosshair, to move to aim at a virtual object in the virtual environment.

FIG. 2 is a flowchart of a crosshair control method according to an embodiment of this application. The method is performed by a terminal. As shown in FIG. 2, the method includes the following operations:

201: The terminal displays a scene interface of a virtual environment, a first virtual object and a crosshair being displayed on the scene interface.

The crosshair indicates an aiming position, which may be an aiming position at which the first virtual object is aimed at, or may be an aiming position at which a second virtual object controlled by the terminal is aimed at. To be specific, when the second virtual object controlled by the terminal performs interaction, the second virtual object interacts with the aiming position indicated by the crosshair. The second virtual object is a virtual object controlled by the terminal. For example, the crosshair displayed on the scene interface is located at a head of the first virtual object, in other words, the crosshair aims at the head of the first virtual object. Subsequently, the second virtual object controlled by the terminal can interact with the head of the first virtual object based on a position that the crosshair aims at.

On the scene interface, the crosshair is located at a center of the scene interface. The crosshair can be displayed in any form. For example, the crosshair is displayed in a form of a point, or displayed in a form of a cross, or displayed in a form of a combination of a circle and a point. The first virtual object is any virtual object in the virtual environment. For example, the first virtual object is a virtual object in the virtual environment that belongs to a camp different from a camp of the second virtual object, or is an AI object.

In this embodiment of this application, a picture of the virtual environment is further displayed on the scene interface. For example, an environment in which the first virtual object is located is further displayed on the scene interface. In some embodiments, the second virtual object may alternatively not be displayed on the scene interface, or a part of the second virtual object is displayed, or the entire second virtual object is displayed.

In some embodiments, the terminal may obtain scene data of the virtual environment, perform rendering based on the scene data to generate the scene interface of the virtual environment, render a three-dimensional first virtual object onto the scene interface based on a position and a posture of the first virtual object in the virtual environment to form a two-dimensional first virtual object, determine a position of the crosshair on the scene interface based on a control operation of a user, and then render the crosshair onto the scene interface based on the position.

202: When the crosshair is located outside an attraction range of the first virtual object, the terminal determines, in response to a first moving operation on the crosshair, a first moving direction of the crosshair that is indicated by the first moving operation.

The attraction range is a range within which the crosshair is automatically controlled to move toward a specific position under a specific condition when the crosshair is located within the attraction range. The attraction range has a specific area, and the crosshair can move to the attraction range under control by the user, or can move toward a specific position under automatic control by the terminal. The specific position is an attraction point. The crosshair automatically moves toward the attraction point under a specific condition, to display an effect of attracting the crosshair. The condition is a condition for determining that the user has an intention to move the crosshair toward the first virtual object. The attraction range is a range including the first virtual object, and may be centered on the first virtual object. The attraction range may be of any shape. For example, the attraction range is a rectangular range centered on the first virtual object, or a circular range centered on the first virtual object. In this embodiment of this application, the first virtual object being located within the attraction range is equivalent to a boundary of the attraction range being set around the first virtual object, and the crosshair being within the boundary indicates that the crosshair is located within the attraction range.

In this embodiment of this application, the user can trigger a moving operation by using the terminal to control the crosshair to move, so that the crosshair aims at a virtual object, and interaction can be subsequently performed with the aimed-at virtual object.

The first moving operation is an operation in any form. For example, the first moving operation is a dragging operation on the crosshair, or a trigger operation on a move option of the crosshair. The move option is configured for controlling the crosshair to move on the scene interface. The first moving direction is a moving direction indicated by the first moving operation, to be specific, a direction in which the user intends to control the crosshair to move when the user triggers the first moving operation by using the terminal.

203: The terminal determines a first attraction point on the first virtual object based on a motion posture of the first virtual object in response to the crosshair being located within the attraction range and the first moving direction pointing to the first virtual object.

In this embodiment of this application, the first virtual object can be in a plurality of motion postures. For example, the first virtual object is in a running, walking, still, squatting, or jumping posture. When the first virtual object is in different motion postures, a relative position of each part of the first virtual object in the virtual environment may vary. When the crosshair is controlled to move toward the first virtual object to aim at the first virtual object, the first virtual object is in different motion postures. In this case, a position at which the crosshair aims at the first virtual object varies. To be specific, the position at which the crosshair aims at the first virtual object is related to the motion posture of the first virtual object.

In this embodiment of this application, the first moving direction of the first moving operation on the crosshair pointing to the first virtual object indicates that the first moving direction is a direction pointing to the first virtual object, and can reflect that the user wants to control the crosshair to aim at the first virtual object. A virtual object in the virtual environment is provided with an attraction range. The attraction range indicates a range for triggering an auxiliary aiming function. The auxiliary aiming function is to help the crosshair to aim at the virtual object. To be specific, the auxiliary aiming function is to control the crosshair to help the crosshair aim at the virtual object as soon as possible. When the crosshair is located within the attraction range of the first virtual object and it is determined that the user intends to control the crosshair to aim at the first virtual object, the auxiliary aiming function is triggered, and the first attraction point on the first virtual object is determined based on the motion posture of the first virtual object, so that the determined first attraction point matches the motion posture. In this way, when the crosshair is subsequently controlled to aim at the first virtual object, the crosshair can be attracted to the first attraction point, to help the crosshair aim at the first virtual object as soon as possible, and ensure that auxiliary aiming can adapt to the motion posture of the first virtual object.

204: The terminal displays, on the scene interface, the crosshair moving toward the first attraction point.

In this embodiment of this application, when the first attraction point on the first virtual object is determined, the crosshair moving toward the first attraction point is displayed on the scene interface, to display the crosshair moving toward the first virtual object, so that the crosshair can aim at the first virtual object as soon as possible.

In the solution provided in this embodiment of this application, a virtual object in the virtual environment is provided with an attraction range. When the crosshair is located within an attraction range of a virtual object and the user controls the crosshair to approach the first virtual object, the first attraction point on the first virtual object is determined based on the motion posture of the first virtual object, so that the crosshair moves toward the first attraction point, and the crosshair can aim at the first virtual object as soon as possible. This auxiliary aiming mode can adapt to various motion postures of the first virtual object, so that the crosshair moves toward the first attraction point that is on an auxiliary aiming line and that matches the motion posture, to avoid low aiming precision in different motion postures of the first virtual object. This helps the user aim at the virtual object by using the crosshair, and ensures that an expected effect of aiming at the first virtual object by the crosshair is closer to a result of an operation performed by the user, so that a sense of manipulation is ensured for the user, human-computer interaction efficiency is improved, and therefore user experience is improved.

Based on the embodiment shown in FIG. 2, in this embodiment of this application, the auxiliary aiming function is triggered only when a second moving speed of the first moving operation is greater than a preset speed threshold, to control the crosshair to move toward the first attraction point on the auxiliary aiming line of the first virtual object, so that the crosshair is attracted to the first attraction point to aim at the first virtual object. For a specific process, refer to the following embodiment.

FIG. 3 is a flowchart of a crosshair control method according to an embodiment of this application. The method is performed by a terminal. As shown in FIG. 3, the method includes the following operations:

301: The terminal displays a scene interface of a virtual environment, a first virtual object and a crosshair being displayed on the scene interface.

In a possible implementation, a second virtual object controlled by the terminal is further displayed on the scene interface.

302: When the crosshair is located outside an attraction range of the first virtual object, the terminal determines, in response to a first moving operation on the crosshair, a first moving direction of the crosshair that is indicated by the first moving operation.

A second moving speed is a moving speed of the first moving operation.

In a possible implementation, the first moving operation on the crosshair is a sliding operation performed by a user on a screen of the terminal. In this case, operation 302 includes: In response to detecting the sliding operation on the screen of the terminal, the terminal determines a direction from a start point to an end point of the sliding operation as a sliding direction of the sliding operation, and determines a ratio of a distance between the start point and the end point to sliding duration as a sliding speed of the sliding operation.

The sliding operation is the first moving operation on the crosshair, the sliding direction of the sliding operation is the first moving direction, and the sliding speed of the sliding operation is the second moving speed of the first moving operation.

In this embodiment of this application, when the terminal displays the scene interface on the screen, the sliding operation triggered by the user on the screen of the terminal is a moving operation on the crosshair displayed on the scene interface. To be specific, the user can move the crosshair by sliding on the screen of the terminal, to adjust a position of the crosshair in the virtual environment. The direction from the start point to the end point of the sliding operation is the sliding direction of the sliding operation. The sliding duration is duration of sliding from the start point to the end point when the user triggers the sliding operation. The distance between the start point and the end point is a displacement of the sliding operation, and a ratio of the displacement to the sliding duration is the sliding speed of the sliding operation.

In this embodiment of this application, the user can control, through the sliding operation on the screen of the terminal, the crosshair to move, to adjust the position of the crosshair in the virtual environment. The sliding direction and the sliding speed are determined based on the start point and the end point of the sliding operation. This not only improves convenience of controlling the crosshair to move, but also can ensure accuracy of the determined sliding direction and sliding speed, to further ensure accuracy of subsequently controlling the crosshair to move.

In some embodiments, a process of determining the sliding direction of the sliding operation includes: constructing a vector from the start point to the end point based on coordinates of the start point and the end point on the screen, the vector being configured for representing the first moving direction.

In this embodiment of this application, the vector is constructed based on the coordinates of the start point and the end point of the sliding operation, and the first moving direction is represented in a form of the vector, to ensure accuracy of the determined first moving direction.

In some embodiments, if the sliding speed is represented by a quantity of pixels that movement spans per unit time, a process of determining the sliding speed of the sliding operation includes: determining a quantity of pixels between the start point and the end point of the sliding operation, and determining a ratio of the quantity of pixels to the sliding duration as the sliding speed.

In a possible implementation, the crosshair is located at a center of the scene interface, the first moving direction is a rotation direction of a virtual camera in the virtual environment, the second moving speed is a rotation angle of the virtual camera in the virtual environment, and the first moving operation on the crosshair is a sliding operation performed by a user on a screen of the terminal. In this case, operation 302 includes: In response to the sliding operation on the crosshair, the terminal determines a direction from a start point to an end point of the sliding operation as the rotation direction of the virtual camera in the virtual environment, determines a ratio of a distance between the start point and the end point to sliding duration as a sliding speed of the sliding operation, and maps the sliding speed of the sliding operation to the virtual environment to obtain the rotation speed of the virtual camera.

The second moving speed is represented in a form of an angle, and is equivalent to an angle of rotation per unit time.

In this embodiment of this application, a picture displayed on the scene interface is a picture captured by the virtual camera in the virtual environment, and the crosshair is always located at the center of the scene interface. When the user moves the crosshair by using the terminal, the terminal only controls the virtual camera in the virtual environment to rotate, to cause a change of the picture displayed on the scene interface, but the crosshair is always displayed at the center of the scene interface. However, the change of the picture displayed on the scene interface is equivalent to a change of a position of the crosshair in the virtual environment. In some embodiments, the position of the crosshair is equivalent to a projection of a line-of-sight direction of the virtual camera on the scene interface. For example, an intersection point between a ray along the line-of-sight direction of the virtual camera and the screen of the scene interface is the projection of the line-of-sight direction of the virtual camera on the scene interface, and a position of the intersection point on the scene interface is the position of the crosshair.

In this embodiment of this application, the sliding direction and the sliding speed of the sliding operation performed by the user on the screen of the terminal are mapped to the virtual environment, and the first moving direction and the second moving speed that are obtained through mapping are used as the rotation direction and the rotation angle of the virtual camera in the virtual environment. In this way, when the virtual camera in the virtual environment subsequently rotates based on the rotation direction and the rotation angle, the terminal can display, on the scene interface, a picture captured by the virtual camera during rotation, to ensure accuracy of control, and further ensure accuracy of a subsequently displayed picture.

In a possible implementation, a move option of the crosshair is displayed on the scene interface, and the crosshair is moved by dragging the move option of the crosshair. In this case, operation 302 includes: In response to a dragging operation on the move option of the crosshair, the terminal determines a dragging direction of the dragging operation as the first moving direction, and determines a product of a dragging distance of the dragging operation and a unit speed as the second moving speed.

In this embodiment of this application, the dragging operation on the move option is equivalent to the first moving operation on the crosshair. The dragging direction is a direction in which the user intends to control the crosshair to move. The unit speed is a speed corresponding to dragging the move option by a unit distance. The dragging distance is a distance between a position to which the move option is dragged and a position of the move option before the move option is dragged. A larger dragging distance indicates a higher moving speed. Therefore, the product of the dragging distance and the unit speed is determined as the second moving speed. The dragging operation on the move option of the crosshair controls the crosshair to move, and the first moving direction and the second moving speed are determined based on the dragging direction and the dragging distance of the dragging operation. This not only improves convenience of controlling the crosshair to move, but also can ensure accuracy of the determined dragging direction and dragging distance, to further ensure accuracy of subsequently controlling the crosshair to move.

In this embodiment of this application, an example in which the first moving direction and the second moving speed of the first moving operation are determined is used for description. However, in another embodiment, operation 302 does not need to be performed, and the first moving direction of the first moving operation is determined in another manner in response to the first moving operation on the crosshair.

303: In response to the crosshair being located within the attraction range of the first virtual object, the first moving direction pointing to the first virtual object, and the second moving speed being greater than a preset speed threshold, the terminal determines an auxiliary aiming line of the first virtual object based on a motion posture of the first virtual object, and determines a first attraction point from the auxiliary aiming line of the first virtual object.

In this embodiment of this application, a virtual object in the virtual environment has an auxiliary aiming line, and the auxiliary aiming line changes with a change of a motion posture of the virtual object. The auxiliary aiming line is a line formed by points on the virtual object that can be attracted by the crosshair. To be specific, when the crosshair aims at the virtual object, the crosshair can aim only at a point on the auxiliary aiming line. The first attraction point is any point determined from the auxiliary aiming line. The second moving speed of the first moving operation on the crosshair being greater than the preset speed threshold indicates that the user intends to move the crosshair toward the first virtual object as soon as possible. Therefore, when the crosshair is located within the attraction range of the first virtual object, the first moving direction is a direction pointing to the first virtual object, and the second moving speed is greater than the preset speed threshold, the first attraction point is determined from the auxiliary aiming line of the first virtual object. When the crosshair subsequently moves toward the first virtual object, the crosshair may be attracted to the first attraction point to aim at the first virtual object.

The preset speed threshold is any value. For example, the preset speed threshold is 8. For example, the first moving operation is a sliding operation performed by the user on the screen of the terminal. When the second moving speed of the sliding operation is not greater than the preset speed threshold, the auxiliary aiming function is not triggered. When the second moving speed is greater than the preset speed threshold, the auxiliary aiming function is enabled. In this case, the second moving speed is mapped to the virtual environment based on a distance between the second virtual object and the first virtual object. As shown in FIG. 4, in response to a moving operation on the crosshair, the crosshair moves from a current position and from a start point to the attraction range of the first virtual object. If the second moving speed is a first speed and the first speed is not greater than the preset speed threshold, the auxiliary aiming function is not triggered. If the second moving speed is a second speed and the second speed is greater than the preset speed threshold, the auxiliary aiming function is triggered.

In a possible implementation, the first virtual object is an object model in a capsule shape, and the attraction range of the first virtual object is a cuboid space range located outside the capsule and including the capsule. In some embodiments, the attraction range is a two-dimensional planar area centered on a model projection of the first virtual object. The model projection of the first virtual object is a two-dimensional projection image of the object model of the first virtual object on the scene interface. For example, the two-dimensional planar area is a rectangular planar area including the model projection.

In a possible implementation, the second moving speed is represented in a form of an angle, and the second moving speed is configured for representing the rotation angle of the virtual camera in the virtual environment. In this case, the preset speed threshold is represented in a form of an angle.

In a possible implementation, the auxiliary aiming line of the first virtual object is a central axis of the first virtual object and is included in the attraction range of the first virtual object, and the auxiliary aiming line is connected to a boundary of the attraction range.

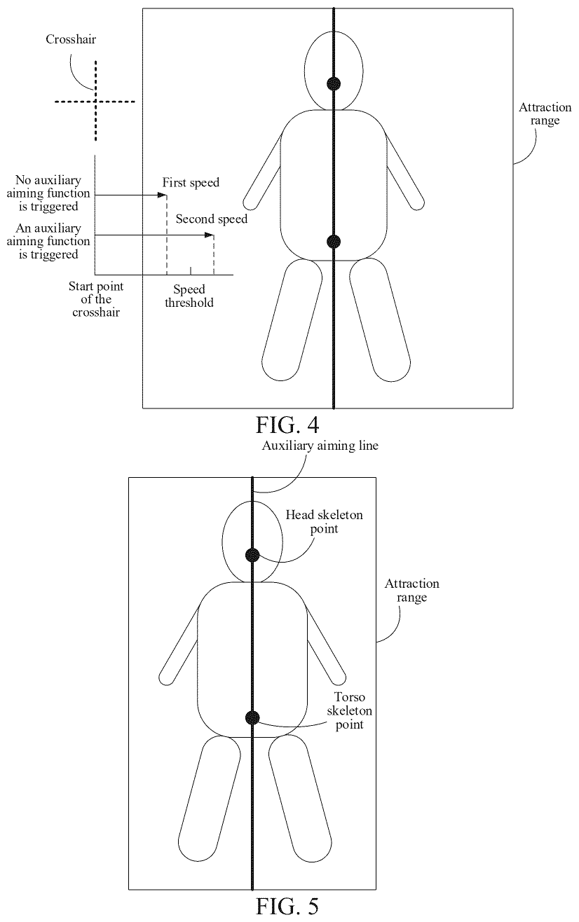

For example, the attraction range is a rectangular range, the first virtual object is located within the attraction range, the auxiliary aiming line of the first virtual object is equivalent to the central axis of the first virtual object, and the auxiliary aiming line runs through the first virtual object and is connected to an upper boundary and a lower boundary of the rectangular range. The rectangular attraction range and the auxiliary aiming line of the first virtual object are shown in FIG. 5.

In a possible implementation, operation 303 includes: determining positions of key points on the first virtual object when the first virtual object is in the motion posture; and connecting the key points based on the positions of the key points to form the auxiliary aiming line.

In this embodiment of this application, the auxiliary aiming line of the first virtual object is formed by connecting the key points on the first virtual object. When the first virtual object is in different motion postures, the positions of the key points on the first virtual object may vary. Therefore, the auxiliary aiming line of the first virtual object changes with a change of the motion posture of the first virtual object.

The key points may be any key points on the first virtual object. For example, the key points are skeleton points on the first virtual object. For example, the skeleton points of the first virtual object include a head skeleton point and a torso skeleton point. The skeleton points of the first virtual object are located inside a body of the first virtual object, and an auxiliary aiming line formed by connecting the skeleton points can serve as the central axis of the first virtual object, and run through the first virtual object.

In this embodiment of this application, the first virtual object can be in a plurality of motion postures. For example, the first virtual object is in a running, walking, still, squatting, or jumping posture. The motion posture of the first virtual object is related to the skeleton points of the first virtual object. To be specific, in the virtual environment, changes of positions of the skeleton points cause a change of the motion posture of the first virtual object. When the first virtual object is in different motion postures at a same position in the virtual environment, the skeleton points of the first virtual object may be at different positions in the virtual environment, but a relative position relationship between the skeleton points remains unchanged. The auxiliary aiming line of the first virtual object is formed by connecting the skeleton points of the first virtual object. When the motion posture of the first virtual object changes, because the positions of the skeleton points of the first virtual object in the virtual environment change, the auxiliary aiming line formed by connecting the skeleton points of the first virtual object changes.

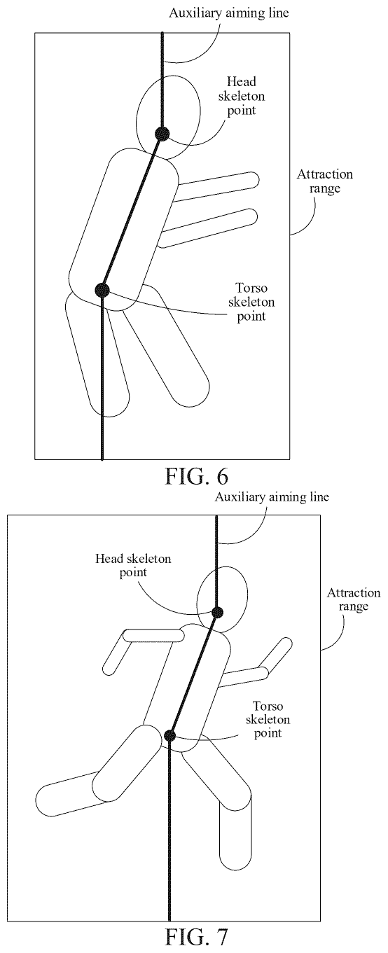

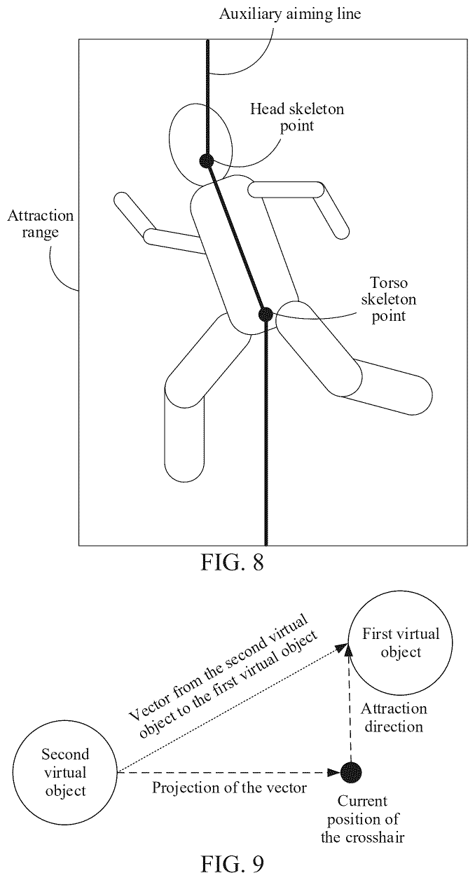

For example, the auxiliary aiming line is formed by connecting the head skeleton point and the torso skeleton point of the first virtual object, and the auxiliary aiming line is connected to the upper boundary and the lower boundary of the rectangular attraction range. When the first virtual object is in different motion postures, the auxiliary aiming line of the first virtual object is shown in FIG. 5 to FIG. 8. In this embodiment of this application, the first virtual object is an object model in a capsule shape, and the attraction range of the first virtual object is a cuboid space range located outside the capsule and including the capsule. In this case, regardless of an angle at which the object model of the first virtual object is projected to the scene interface, for example, regardless of whether the first virtual object is projected to the scene interface at an angle facing away from the second virtual object or is projected to the scene interface at an angle facing a side of the second virtual object, the auxiliary aiming line of the first virtual object is always equivalent to the central axis of the first virtual object, and is included in the attraction range.

In this embodiment of this application, the auxiliary aiming function is triggered only when the second moving speed is greater than the preset speed threshold and the first attraction point is determined from the auxiliary aiming line of the first virtual object. However, in another embodiment, operation 303 does not need to be performed, and the first attraction point on the first virtual object is determined based on the motion posture of the first virtual object when the crosshair is located within the attraction range of the first virtual object and the first moving direction points to the first virtual object.

304: The terminal determines a third moving speed based on the second moving speed and the distance between the second virtual object controlled by the terminal and the first virtual object, the third moving speed being negatively correlated with the distance.

In this embodiment of this application, when the crosshair is controlled to move to aim at the first virtual object in the virtual environment, a larger distance between the first virtual object and the second virtual object indicates a smaller displacement by which the crosshair moves from a current position to aim at the first virtual object, and a shorter distance between the first virtual object and the second virtual object indicates a larger displacement by which the crosshair moves from a current position to aim at the first virtual object. Therefore, the second moving speed is mapped to the virtual environment based on the second moving speed of the first moving operation and the distance between the second virtual object and the first virtual object, to obtain the third moving speed negatively correlated with the distance, so that the crosshair can subsequently move at the third moving speed. This can ensure consistent user experience when the user controls, by using the terminal, the crosshair to aim at virtual objects at different distances in the virtual environment.

In a possible implementation, operation 304 includes: determining the third moving speed based on the second moving speed and the distance between the second virtual object and the first virtual object when the second moving speed is greater than the preset speed threshold.

In this embodiment of this application, the second moving speed of the first moving operation on the crosshair being greater than the preset speed threshold indicates that the user intends to move the crosshair toward the first virtual object as soon as possible. The second moving speed is mapped to the virtual environment based on the distance between the second virtual object and the first virtual object only when the second moving speed is greater than the preset speed threshold, so that the crosshair moving at the third moving speed is subsequently displayed, and the determined third moving speed matches the intention of the user. This ensures accuracy of the determined third moving speed, and further ensures that the crosshair can subsequently aim at the first virtual object as soon as possible, to improve human-computer interaction efficiency.

In this embodiment of this application, when the crosshair is located within the attraction range of the first virtual object, the first moving direction points to the first virtual object, and the second moving speed is greater than the preset speed threshold, the first attraction point is first determined, and then the third moving speed is determined. However, in another embodiment, operations 303 and 304 do not need to be performed, and another manner is used: When the crosshair is located within the attraction range of the first virtual object, the first moving direction points to the first virtual object, and the second moving speed is greater than the preset speed threshold, the terminal determines the third moving speed based on the second moving speed and the distance between the second virtual object controlled by the terminal and the first virtual object, the third moving speed being negatively correlated with the distance. The terminal determines the auxiliary aiming line of the first virtual object based on the motion posture of the first virtual object, and determines the first attraction point from the auxiliary aiming line of the first virtual object.

305: The terminal displays, on the scene interface, the crosshair moving toward the first attraction point at the third moving speed.

In this embodiment of this application, the second moving speed of the first moving operation on the crosshair is mapped to the virtual environment based on the distance between the first virtual object and the second virtual object, to obtain the third moving speed. The crosshair moving toward the first attraction point at the third moving speed being displayed on the scene interface is equivalent to the crosshair moving toward the first virtual object at the third moving speed, to be subsequently attracted to the first attraction point on the virtual object, so that the crosshair can aim at the first virtual object as soon as possible.

In a possible implementation, the crosshair moving toward the first attraction point is presented by rotation of the virtual camera in the virtual environment, and the third moving speed is equivalent to the rotation angle of the virtual camera in the virtual environment. In this case, operation 305 includes: The terminal controls the virtual camera to rotate toward the first attraction point at the third moving speed, so that the crosshair moving toward the first attraction point at the third moving speed is displayed on the scene interface.

In this embodiment of this application, a picture obtained by the virtual camera by photographing the virtual environment is displayed on the scene interface. The virtual camera is controlled to move toward the first attraction point on the first virtual object at the third moving speed, so that a picture captured by the virtual camera during rotation is displayed on the scene interface. The picture displayed on the scene interface constantly changes, but the crosshair is always displayed at the center of the scene interface. In this way, the crosshair moving toward the first attraction point at the third moving speed is displayed.

In this embodiment of this application, an example in which the crosshair moves toward the first attraction point on the auxiliary aiming line of the first virtual object is used for description. However, in another embodiment, operations 304 and 305 do not need to be performed, and the crosshair moving toward the first attraction point is displayed on the scene interface in another manner.

In the solution provided in this embodiment of this application, a virtual object in the virtual environment is provided with an attraction range. When the crosshair is located within an attraction range of a virtual object and the user controls the crosshair to approach the first virtual object, the first attraction point on the first virtual object is determined based on the motion posture of the first virtual object, so that the crosshair moves toward the first attraction point, and the crosshair can aim at the first virtual object as soon as possible. This auxiliary aiming mode can adapt to various motion postures of the first virtual object, so that the crosshair moves toward the first attraction point that is on an auxiliary aiming line and that matches the motion posture, to avoid low aiming precision in different motion postures of the first virtual object. This helps the user aim at the virtual object by using the crosshair, and ensures that an expected effect of aiming at the first virtual object by the crosshair is closer to a result of an operation performed by the user, so that a sense of manipulation is ensured for the user, human-computer interaction efficiency is improved, and therefore user experience is improved.

In this embodiment of this application, the second moving speed of the first moving operation on the crosshair is mapped to the virtual environment based on the distance between the first virtual object and the second virtual object, to obtain the third moving speed, so that the crosshair moves toward the first virtual object at the third moving speed, and the crosshair can aim at the first virtual object as soon as possible. In addition, the third moving speed is negatively correlated with the distance. This can ensure consistent user experience when the user controls, by using the terminal, the crosshair to aim at virtual objects at different distances in the virtual environment, help the user aim at the virtual object by using the crosshair, improve human-computer interaction efficiency, and therefore improve user experience.

In this embodiment of this application, the first virtual object has only one auxiliary aiming line, and the auxiliary aiming line is equivalent to the central axis of the first virtual object. The first attraction point of the crosshair is determined from the auxiliary aiming line, and the crosshair moving toward the first attraction point at the third moving speed to be attracted to the first attraction point and aim at the first virtual object is displayed. This auxiliary aiming mode can adapt to various motion postures of the first virtual object. The crosshair can move toward the first attraction point on the auxiliary aiming line regardless of any motion posture of the first virtual object. This avoids low aiming precision in different motion postures of the first virtual object, and avoids impact on aiming at the first virtual object by the crosshair, so that an expected effect is achieved and is closer to a result of an operation performed by the user. In this way, a sense of manipulation is ensured for the user, and the user can control, by using the terminal, the crosshair to perform aiming, so that user experience is improved. In addition, in this solution, it is unnecessary to separately configure different auxiliary aiming configurations for different motion postures of the first virtual object, so that an operation of configuring auxiliary aiming configurations in different motion postures is omitted.

In this embodiment of this application, an attraction point configured for aiming at a virtual object is determined by using an auxiliary aiming line, so that the crosshair can smoothly move and aim at the virtual object. This avoids a case in which the crosshair is pulled by a plurality of attraction points when a plurality of fixed attraction points are configured on a virtual object, to improve smoothness of operations and further improve user experience.

Based on the embodiment shown in FIG. 3, the embodiments of this application provide a schematic diagram of the crosshair moving toward the first virtual object. As shown in FIG. 9, the crosshair is at a current position, and is to move toward the first virtual object along an attraction direction, so that the crosshair is attracted to the first virtual object.

Based on the embodiment shown in FIG. 3, a process of determining the third moving speed includes the following six manners.

A first manner includes the following operations 1 and 2:

Operation 1: Query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object.

In this embodiment of this application, the first virtual object is referred to as a to-be-aimed-at target virtual object, the first correspondence is a correspondence applicable when the crosshair moves toward the target virtual object, and the first correspondence includes a distance and a corresponding adjustment coefficient. In this case, based on the distance between the second virtual object and the first virtual object, the first adjustment coefficient corresponding to the distance can be determined from the first correspondence, to ensure accuracy of the determined adjustment coefficient.

The distance can be measured in any unit. For example, the distance is measured in centimeters. The first correspondence can be represented in any form. For example, the first correspondence is represented in a form of a line graph, an X axis in the line graph is configured for representing a distance, a Y axis in the line graph is configured for representing an adjustment parameter, and a curve in the line graph can represent an adjustment parameter corresponding to each distance. For example, the first correspondence is Auto Aim Close Scale By Dist. The first adjustment coefficient is any value. For example, the first adjustment coefficient is a value greater than 0 and less than 1, or the first adjustment coefficient is 1, or the first adjustment coefficient is a value greater than 1.

In a possible implementation, the distance and the corresponding adjustment coefficient in the first correspondence are negatively correlated with each other.

For example, in the first correspondence, a larger distance corresponds to a smaller adjustment coefficient, and a shorter distance corresponds to a larger adjustment coefficient.

In this embodiment of this application, a larger distance between the first virtual object and the second virtual object indicates a smaller displacement by which the crosshair moves from a current position to aim at the first virtual object, and a shorter distance between the first virtual object and the second virtual object indicates a larger displacement by which the crosshair moves from a current position to aim at the first virtual object. Therefore, the distance and the corresponding adjustment coefficient in the first correspondence are negatively correlated with each other. The adjustment coefficient is found from the first correspondence to obtain the second moving speed of the crosshair in the virtual environment, so that the second moving speed is negatively correlated with the distance, to ensure consistent user experience when the user controls, by using the terminal, the crosshair to aim at virtual objects at different distances in the virtual environment.

Operation 2: Determine a product of the second moving speed and the first adjustment coefficient corresponding to the distance as the third moving speed.

In this embodiment of this application, the first adjustment coefficient is equivalent to attraction strength of the crosshair approaching the first virtual object. The product of the first adjustment coefficient and the second moving speed is used as the third moving speed, so that the attraction strength can be reflected when the crosshair subsequently moves toward the first virtual object at the third moving speed.

In this embodiment of this application, the first correspondence is a correspondence applicable when the crosshair moves toward the first virtual object. When the crosshair moves toward the first virtual object, the first correspondence is queried based on the distance between the second virtual object and the first virtual object, and the second moving speed is mapped to the virtual environment based on the found first adjustment coefficient and is used as a moving speed of the crosshair, so that the obtained third moving speed is related to the distance, to ensure accuracy of the determined third moving speed.

In this application, an example in which the product of the first adjustment coefficient and the second moving speed is used as the third moving speed is used for description. However, in another embodiment, operation 2 does not need to be performed, and the second moving speed is mapped to the virtual environment based on the first adjustment coefficient in another manner, to obtain the third moving speed.

In a second manner, the crosshair is displayed when the second virtual object holds a virtual item. This manner includes the following operations 1 to 3:

Operation 1: Query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object.

Operation 1 herein is similar to operation 1 in the first manner. Details are not described herein again.

Operation 2: Obtain an adjustment coefficient corresponding to the virtual item.

In this embodiment of this application, when the second virtual object controlled by the terminal holds the virtual item, the crosshair displayed on the scene interface is equivalent to a crosshair of the virtual item, and interaction can be subsequently performed, by using the held virtual item, with a position that the crosshair aims at. Different virtual items may correspond to different adjustment coefficients. An adjustment coefficient corresponding to a virtual item can reflect flexibility of adjusting a crosshair of the virtual item. A larger adjustment coefficient corresponding to a virtual item indicates higher flexibility of a crosshair of the virtual item, and a smaller adjustment coefficient corresponding to a virtual item indicates lower flexibility of a crosshair of the virtual item.

In a possible implementation, operation 2 includes: The terminal queries a third correspondence based on an item identifier of the virtual item held by the second virtual object, to obtain the adjustment coefficient corresponding to the virtual item.

The third correspondence is a correspondence between the item identifier and the adjustment coefficient. The item identifier represents the corresponding virtual item, and the item identifier can be represented in any form. For example, the item identifier is represented by a sequence number or an item name.

Operation 3: Determine a product of the adjustment coefficient corresponding to the virtual item, the first adjustment coefficient corresponding to the distance, and the second moving speed as the third moving speed.

In this embodiment of this application, both the first adjustment coefficient corresponding to the distance and the adjustment coefficient corresponding to the virtual item held by the second virtual object are considered. The second moving speed is mapped to the virtual environment based on the adjustment coefficient corresponding to the virtual item and the first adjustment coefficient corresponding to the distance, to obtain the moving speed of the crosshair, so that the moving speed of the crosshair is related to the distance and the virtual item held by the second virtual object, and the moving speed of the crosshair matches the virtual item held by the second virtual object. Further, a difference in difficulty in manipulating crosshairs of different virtual items can be reflected, to ensure accuracy of the determined moving speed of the crosshair.

A third manner includes the following operations 1 and 3:

Operation 1: Query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object.

Operation 1 herein is similar to operation 1 in the first manner. Details are not described herein again.

Operation 2: Obtain a scaling ratio, the scaling ratio being configured for mapping the second moving speed of the first moving operation to the virtual environment.

In this embodiment of this application, the user controls, through the first moving operation performed on the crosshair by using the terminal, the crosshair to move in the virtual environment. The second moving speed of the first moving operation can be mapped, based on the scaling ratio, to the virtual environment as a moving speed of the crosshair, so that the crosshair moves in the virtual environment at the moving speed of the crosshair.

The scaling ratio is any value. In this embodiment of this application, if the scaling ratio is greater than 1, the second moving speed of the first moving operation is increased, and an increased moving speed is used as a moving speed of the crosshair in the virtual environment; if the scaling ratio is 1, the second moving speed of the first moving operation is used as a moving speed of the crosshair in the virtual environment; or if the scaling ratio is less than 1, the second moving speed of the first moving operation is decreased, and a decreased moving speed is used as a moving speed of the crosshair in the virtual environment.

Operation 3: Determine a product of the first adjustment coefficient corresponding to the distance, the scaling ratio, and the second moving speed as the third moving speed.

In this embodiment of this application, both the first adjustment coefficient corresponding to the distance and the scaling ratio configured for mapping the second moving speed of the first moving operation to the virtual environment are considered. The second moving speed is mapped to the virtual environment based on the scaling ratio and the first adjustment coefficient corresponding to the distance, to obtain a moving speed of the crosshair, so that the moving speed of the crosshair is related to the distance and the scaling ratio, and the user can precisely control the crosshair to move in the virtual environment by triggering a moving operation on the crosshair, to ensure accuracy of the determined moving speed of the crosshair.

A fourth manner includes the following operations 1 and 3:

Operation 1: Query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object.

Operation 2: Obtain an adjustment coefficient corresponding to the second moving speed, the adjustment coefficient being positively correlated with the second moving speed.

In this embodiment of this application, when the second moving speed of the first moving operation on the crosshair is greater than the preset speed threshold, a higher second moving speed indicates a higher speed at which the crosshair moves toward the first virtual object. During obtaining of the adjustment coefficient positively correlated with the second moving speed, a higher second moving speed indicates a larger adjustment coefficient obtained, and a lower second moving speed indicates a smaller adjustment coefficient obtained. This ensures that a higher second moving speed subsequently indicates a larger range of adjusting the moving speed of the crosshair, to ensure a higher speed at which the crosshair moves toward the first virtual object.

Operation 3: Determine a product of the first adjustment coefficient corresponding to the distance, the adjustment coefficient corresponding to the second moving speed, and the second moving speed as the third moving speed.

In this embodiment of this application, both the first adjustment coefficient corresponding to the distance and the adjustment coefficient corresponding to the second moving speed are considered. The second moving speed is mapped to the virtual environment based on the adjustment coefficient corresponding to the second moving speed and the first adjustment coefficient corresponding to the distance, to obtain a moving speed of the crosshair, so that the moving speed of the crosshair is related to the distance and the adjustment coefficient corresponding to the second moving speed, and the moving speed of the crosshair is positively correlated with the second moving speed. In this way, a higher second moving speed indicates a larger range of adjusting the moving speed of the crosshair, to ensure a higher speed at which the crosshair moves toward the first virtual object, ensure efficiency of attracting the crosshair to the first virtual object, and further improve human-computer interaction efficiency.

For example, the preset speed threshold is 8. Compared with the second moving speed being 10, when the second moving speed is 20, during obtaining of the moving speed of the crosshair, a larger range of adjusting the moving speed of the crosshair indicates higher auxiliary aiming strength of the crosshair, so that the crosshair can be attracted to the first virtual object more quickly, to aim at the first virtual object.

A fifth manner includes the following operations 1 and 3:

Operation 1: Query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object.

Operation 2: Query a seventh correspondence based on a distance between the crosshair and the first virtual object to obtain an adjustment coefficient corresponding to the distance between the crosshair and the first virtual object.

In this embodiment of this application, the first virtual object is referred to as a to-be-aimed-at target virtual object, the seventh correspondence is a correspondence applicable when the crosshair moves toward the target virtual object, and the seventh correspondence includes the distance between the crosshair and the first virtual object, and the corresponding adjustment coefficient. In this case, based on the distance between the crosshair and the first virtual object, the adjustment coefficient corresponding to the distance between the crosshair and the first virtual object can be determined from the seventh correspondence, to ensure accuracy of the determined adjustment coefficient.

In a possible implementation, the adjustment coefficient corresponding to the distance between the crosshair and the first virtual object is negatively correlated with the distance between the crosshair and the first virtual object. In this embodiment of this application, a shorter distance between the crosshair and the first virtual object indicates a lower moving speed of the crosshair, to avoid missing the first virtual object due to an excessively high moving speed of the crosshair, and ensure that the crosshair can be precisely attracted to the first virtual object.

Operation 3: Determine a product of the first adjustment coefficient corresponding to the distance between the second virtual object and the first virtual object, the adjustment coefficient corresponding to the distance between the crosshair and the first virtual object, and the second moving speed as the third moving speed.

In this embodiment of this application, both the first adjustment coefficient corresponding to the distance between the second virtual object and the first virtual object and the adjustment coefficient corresponding to the distance between the crosshair and the first virtual object are considered. The second moving speed is mapped to the virtual environment based on the first adjustment coefficient and the adjustment coefficient corresponding to the distance between the crosshair and the first virtual object, to obtain a moving speed of the crosshair, so that the moving speed of the crosshair is related to the distance between the second virtual object and the first virtual object and the distance between the crosshair and the first virtual object. In this way, the moving speed of the crosshair varies with the distance between the crosshair and the first virtual object, to ensure that the crosshair can be precisely attracted to the first virtual object without a plurality of times of adjustment by the user. This ensures efficiency of attracting the crosshair to the first virtual object, and therefore improves human-computer interaction efficiency.

A sixth manner includes the following operations 1 and 3:

Operation 1: Query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object.

Operation 2: Obtain a basic adjustment coefficient.

The basic adjustment coefficient is any value, and the basic adjustment coefficient is a coefficient configured for mapping a moving speed of a moving operation to the virtual environment.

Operation 3: Determine a product of the first adjustment coefficient corresponding to the distance, the basic adjustment coefficient, and the second moving speed as the third moving speed.

In this embodiment of this application, both the first adjustment coefficient corresponding to the distance and the basic adjustment coefficient configured for mapping a moving speed of a moving operation to the virtual environment are considered. The second moving speed is mapped to the virtual environment based on the basic adjustment coefficient and the first adjustment coefficient corresponding to the distance, to obtain a moving speed of the crosshair, so that the moving speed of the crosshair is related to the distance and the basic adjustment coefficient, to ensure accuracy of the determined moving speed of the crosshair.

The foregoing five manners of determining the third moving speed may be combined in different manners. For example, three of the foregoing manners are combined, and a product of the basic adjustment coefficient, the first adjustment coefficient corresponding to the distance, the adjustment coefficient corresponding to the virtual item, and the second moving speed is determined as the third moving speed. In this embodiment of this application, a product of the basic adjustment coefficient, the first adjustment coefficient corresponding to the distance, the scaling ratio, and the adjustment coefficient corresponding to the virtual item is equivalent to the auxiliary aiming strength. If a moving operation on the crosshair is a sliding operation performed by the user on the screen of the terminal, the adjustment coefficient corresponding to the virtual item is equivalent to an attraction strength correction coefficient based on the sliding operation.

Based on the embodiment shown in FIG. 3, in this application, the first attraction point of the crosshair may be further determined from the auxiliary aiming line in three manners.

First manner: Determine the first attraction point based on an intersection point between a ray along the first moving direction and the auxiliary aiming line, a current position of the crosshair being a start point of the ray.

In this embodiment of this application, in response to the first moving operation on the crosshair, the crosshair moving along the first moving direction is displayed on the scene interface. To be specific, the ray that uses the current position of the crosshair as the start point and that is along the first moving direction can indicate a moving direction of the crosshair, and the crosshair is attracted to a point on the auxiliary aiming line when aiming at the first virtual object. In this case, the intersection point between the ray and the auxiliary aiming line is equivalent to a point that is on the first virtual object and that the crosshair may aim at when moving along the first moving direction. Therefore, the first attraction point is determined based on the intersection point between the ray along the first moving direction and the auxiliary aiming line.

In this embodiment of this application, the first attraction point is determined based on the intersection point between the auxiliary aiming line and the ray that uses the current position of the crosshair as the start point and that is along the first moving direction, to ensure that the crosshair can move along the first moving direction of the first moving operation and can be accurately attracted to the first virtual object, to ensure accuracy of movement of the crosshair, and ensure accuracy of attracting the crosshair.

In a possible implementation, the auxiliary aiming line includes a first line segment, a second line segment, and a third line segment, the first line segment is a line segment between a head key point of the first virtual object and the upper boundary of the attraction range, the second line segment is a line segment between a torso key point of the first virtual object and the lower boundary of the attraction range, and the third line segment is a line segment between the head key point and the torso key point. In this case, the first manner includes: when the intersection point is an intersection point between the ray and the first line segment, determining the head key point as the first attraction point; or when the intersection point is an intersection point between the ray and the second line segment, determining the torso key point as the first attraction point; or when the intersection point is an intersection point between the ray and the third line segment, determining the intersection point between the ray and the third line segment as the first attraction point.

In this embodiment of this application, the first virtual object includes the head key point and the torso key point, and the head key point and the torso key point are equivalent to the head skeleton point and the torso skeleton point of the first virtual object. Regardless of any motion posture of the first virtual object, a relative position relationship between the head key point and the torso key point remains unchanged, and the auxiliary aiming line of the first virtual object is formed by connecting the head key point, the torso key point, and the upper boundary and the lower boundary of the attraction range of the first virtual object. The first line segment is formed by connecting the head key point and the upper boundary of the attraction range. In some embodiments, the first line segment is a vertical line segment. The second line segment is formed by connecting the torso key point and the lower boundary of the attraction range. In some embodiments, the second line segment is a vertical line segment. The third line segment is formed by connecting the head key point and the torso key point. The third line segment may be a vertical line segment or an oblique line segment. When the first virtual object is in different motion postures, positions of the head key point and the torso key point in the virtual environment may vary, but the relative position relationship between the head key point and the torso key point remains unchanged. Therefore, a pattern of the third line segment is related to the motion posture of the first virtual object. For example, when the first virtual object stands vertically, the third line segment is a vertical line segment; or when the first virtual object squats, the third line segment is an oblique line segment.

In this embodiment of this application, considering a habit of a user controlling a virtual object to interact with another virtual object in a game, the auxiliary aiming line is divided into a plurality of line segments, and the first attraction point can be determined in different manners based on intersection points between the ray along the first moving direction and different line segments on the auxiliary aiming line, to ensure that the determined first attraction point conforms to an intention of the user, and therefore ensure accuracy of the determined first attraction point and improve user experience.

In this embodiment of this application, an example in which the auxiliary aiming line includes three line segments is used for description. However, in another embodiment, the auxiliary aiming line may alternatively include a plurality of line segments. To be specific, the first virtual object includes a plurality of key points, the plurality of key points are connected to the upper boundary and the lower boundary of the attraction range to form the auxiliary aiming line of the first virtual object. In addition, during determining of the first attraction point, if the ray intersects a line segment that is on the auxiliary aiming line and that is connected to the upper boundary, a key point in the line segment connected to the upper boundary is determined as the first attraction point according to the manner of determining the first attraction point when the ray intersects the first line segment; if the ray intersects a line segment that is on the auxiliary aiming line and that is connected to the lower boundary, a key point in the line segment connected to the lower boundary is determined as the first attraction point according to the manner of determining the first attraction point when the ray intersects the second line segment; or if the ray intersects a line segment that is on the auxiliary aiming line and that is not connected to the upper boundary or the lower boundary, an intersection point between the ray and the line segment is determined as the first attraction point according to the manner of determining the first attraction point when the ray intersects the third line segment.

Second manner: Determine the first attraction point based on a point that is on the auxiliary aiming line and that is on a same horizontal line as the crosshair.

In this embodiment of this application, the user intends to control the crosshair to move toward the first virtual object to aim at the first virtual object as soon as possible, but the first moving operation triggered by the user is not sufficiently accurate, and consequently, it takes a long time to aim at the first virtual object when the crosshair moves along the first moving direction. Therefore, in response to the first moving operation on the crosshair, a point that is on the auxiliary aiming line and that is on a same horizontal line as a current position of the crosshair is determined as the first attraction point, so that a distance between the determined first attraction point and the current position of the crosshair is as short as possible, to ensure that the crosshair can be attracted to the first virtual object as soon as possible when subsequently moving toward the attraction point. This improves aiming efficiency, also improves human-computer interaction efficiency, and further improves user experience.

In a possible implementation, the auxiliary aiming line includes a first line segment, a second line segment, and a third line segment, the first line segment is a line segment between a head key point of the first virtual object and the upper boundary of the attraction range, the second line segment is a line segment between a torso key point of the first virtual object and the lower boundary of the attraction range, and the third line segment is a line segment between the head key point and the torso key point. The determining the first attraction point based on a point that is on the auxiliary aiming line and that is on a same horizontal line as the crosshair includes: when the crosshair and a point in the first line segment are located on a same horizontal line, determining the head key point as the first attraction point; or when the crosshair and a point in the second line segment are located on a same horizontal line, determining the torso key point as the first attraction point; or when the crosshair and a point in the third line segment are located on a same horizontal line, determining, as the first attraction point, the point that is in the third line segment and that is located on the same horizontal line as the crosshair.

In this embodiment of this application, considering a habit of a user in controlling a virtual object to interact with another virtual object in a game, an auxiliary aiming line is divided into a plurality of line segments. In response to a first moving operation on a crosshair, different line segments on the auxiliary aiming line and a current position of the crosshair is located at points on a same horizontal line, and the first attraction point may be determined in different manners, to ensure that the determined first attraction point conforms to an intention of the user. In addition, the crosshair may be extracted from the first virtual object as soon as possible when moving toward the determined first attraction point, to implement aiming at the first virtual object. This not only ensures accuracy of the determined first attraction point, but also improves aiming efficiency. Human computer interaction efficiency is also improved, thereby improving user experience.

Third manner: Determine a point that is on the auxiliary aiming line and that has a shortest distance from the crosshair as the first attraction point.

In this embodiment of this application, in response to the first moving operation on the crosshair, the point that is on the auxiliary aiming line and that has the shortest distance from the crosshair is determined as the first attraction point, so that a distance between the determined first attraction point and a current position of the crosshair is the shortest, to ensure that the crosshair can be attracted to the first virtual object as soon as possible when subsequently moving toward the attraction point. This improves aiming efficiency, also improves human-computer interaction efficiency, and further improves user experience.

Based on the embodiment shown in FIG. 3, in this embodiment of this application, for example, the attraction range may alternatively include a plurality of subranges, and the first attraction point is located within a first subrange of the plurality of subranges. When the crosshair switches between the plurality of subranges, a new attraction point may be determined for the crosshair, and a moving speed of the crosshair is adjusted, to ensure smooth transition of the moving speed when the crosshair moves between the plurality of subranges. To be specific, the method further includes the following operations 1 to 3:

Operation 1: In response to the crosshair entering a second subrange from the first subrange, determine, from the auxiliary aiming line, a second attraction point located within the second subrange, the second subrange being a subrange adjacent to the first subrange among the plurality of subranges.

In this embodiment of this application, based on the embodiment shown in FIG. 3, the crosshair moves toward the first attraction point located within the first subrange, and then the crosshair may be attracted to the first attraction point, or may only be closer to the first attraction point but not attracted to the first attraction point. In this case, in response to another moving operation on the crosshair, a moving direction of the crosshair changes, and the crosshair enters the second subrange from the first subrange. In this case, the second attraction point located within the second subrange is determined from the auxiliary aiming line, to control the crosshair to move toward the second attraction point to aim at the first virtual object when moving within the second subrange.

A process of determining an attraction point within the second subrange from the auxiliary aiming line in response to the crosshair entering the second subrange from the first subrange is similar to the foregoing process of determining the first attraction point. Details are not described herein again.

In a possible implementation, the auxiliary aiming line includes a plurality of skeleton points of the first virtual object, and the attraction range is divided into a plurality of subranges based on horizontal lines on which the plurality of skeleton points are located.

For example, the auxiliary aiming line includes two skeleton points of the first virtual object: the head skeleton point and the torso skeleton point. In this case, the attraction range is divided into three subranges, the 1^{st} subrange is an attraction range above a horizontal line on which the head skeleton point is located, the 2^{nd} subrange is an attraction range between the horizontal line on which the head skeleton point is located and a horizontal line on which the torso skeleton point is located, and the 3^{rd} subrange is an attraction range below the horizontal line on which the torso skeleton point is located. For example, the first subrange is the attraction range above the horizontal line on which the head skeleton point is located, and the second subrange is the attraction range between the horizontal line on which the head skeleton point is located and the horizontal line on which the torso skeleton point is located; or the first subrange is the attraction range between the horizontal line on which the head skeleton point is located and the horizontal line on which the torso skeleton point is located, and the second subrange is the attraction range below the horizontal line on which the torso skeleton point is located.

In some embodiments, during configuration of the first virtual object, a plurality of skeleton points are configured for the first virtual object by using an auto aim target component, so that an auxiliary aiming line is subsequently formed by using the plurality of skeleton points configured, to aim at the first virtual object.

In a possible implementation, before operation 1, a process of the crosshair moving from the first subrange to the second subrange includes: in response to a third moving operation on the crosshair, determining a moving direction and a moving speed of the third moving operation; and when the crosshair is located within the first subrange of the first virtual object and the moving direction of the third moving operation points to the second subrange, determining a sixth moving speed based on the moving speed of the third moving operation and the distance between the second virtual object and the first virtual object, and displaying, on the scene interface, the crosshair moving toward the second subrange at the sixth moving speed.

A process of controlling the crosshair to move in response to the third moving operation is similar to the foregoing process of controlling the crosshair to move in response to the first moving operation. Details are not described herein again.

In this embodiment of this application, in response to the third moving operation on the crosshair, the crosshair moving from the first subrange to the second subrange is displayed on the scene interface. When it is determined that the crosshair enters the second subrange, the second attraction point is determined according to operation 1. A moving direction of the crosshair can be controlled in response to a moving operation on the crosshair, to improve flexibility of controlling the crosshair, and further meet a requirement of the user and improve user experience.

Operation 2: Determine a first moving speed based on existence duration of the crosshair within the second subrange and a current moving speed of the crosshair.

The existence duration is duration in which the crosshair is located within the second subrange and that is counted when the crosshair enters the second subrange. The current moving speed of the crosshair is a moving speed at which the crosshair enters the second subrange. For example, based on the embodiment shown in FIG. 3, the crosshair moves toward the first attraction point within the first subrange, and then the crosshair moves from the first subrange to the second subrange in response to a moving operation on the crosshair. During the movement, the crosshair may first move within the first subrange by a specific distance, and then enter the second subrange, and a moving speed at which the crosshair enters the second subrange is the current moving speed of the crosshair in operation 2.

In this embodiment of this application, with movement of the crosshair between the plurality of subranges, different attraction points are determined for the crosshair. For different attraction points, the moving speed of the crosshair is adjusted, so that the moving speed of the crosshair matches a current attraction point, to be specific, strength of attracting the crosshair by the current attraction point matches the moving speed of the crosshair. During adjustment of the moving speed of the crosshair, the moving speed of the crosshair is adjusted based on time at which the crosshair enters the second subrange, to ensure that a moving speed at which the crosshair moves between the plurality of subranges is smoother. This further ensures that the moving speed of the crosshair matches control of the user over the crosshair, to ensure precision and controllability of controlling the crosshair.

In a possible implementation, operation 2 includes: querying a fourth correspondence based on the existence duration of the crosshair within the second subrange to obtain an adjustment coefficient corresponding to the existence duration, and determining a product of the adjustment coefficient corresponding to the existence duration and the current moving speed of the crosshair as the first moving speed.

In this embodiment of this application, the fourth correspondence includes a correspondence between an adjustment coefficient and existence duration of the crosshair within the second subrange when the crosshair enters the second subrange from the first subrange. For example, the fourth correspondence is represented in a form of a line graph, an X axis in the line graph represents existence duration, a Y axis in the line graph represents an adjustment coefficient, and a curve in the line graph represents an adjustment coefficient corresponding to each period of existence duration. For example, the fourth correspondence is Change Aim Point Time Scale.

Operation 3: Display, on the scene interface, the crosshair moving toward the second attraction point at the first moving speed.

In this embodiment of this application, the crosshair moving toward the second attraction point at the first moving speed being displayed on the scene interface is equivalent to the crosshair moving toward the first virtual object at the first moving speed, so that the crosshair is subsequently attracted to the second attraction point on the virtual object.

In this embodiment of this application, an example in which the moving speed of the crosshair is adjusted only once is used for description. However, in another embodiment, with an increase in the existence duration of the crosshair within the second subrange, the moving speed of the crosshair is adjusted in real time according to operations 2 and 3, to show that a speed at which the crosshair moves toward the second attraction point gradually increases, and show that strength of attracting the crosshair by the second attraction point gradually increases with duration in which the crosshair is located within the second subrange after the crosshair enters the second subrange.

In this embodiment of this application, when the attraction range includes a plurality of subranges and the crosshair switches between the plurality of subranges, a new attraction point can be determined for the crosshair, a moving speed is obtained based on existence duration of the crosshair within a new subrange that the crosshair enters, and the crosshair moving toward the new attraction point at the moving speed is displayed, so that the moving speed of the crosshair within the new subrange that the crosshair enters matches the existence duration, and the moving speed of the crosshair gradually changes with the existence duration. This can ensure smooth transition of the moving speed when the crosshair moves between the plurality of subranges, ensure that the moving speed of the crosshair matches control of the user over the crosshair, and further improve precision and controllability of controlling the crosshair.

The crosshair control solution provided in this embodiment of this application can adapt to precise aiming at each part of a to-be-aimed-at virtual object at different distances between a virtual object controlled by the terminal and the to-be-aimed-at virtual object, can adapt to a plurality of motion postures of the second virtual object, and can assist the crosshair in aiming at a virtual object. In addition, when the crosshair moves between the plurality of subranges within the attraction range of the aimed-at first virtual object, a moving speed of the crosshair can be optimized, to enable smooth transition of the moving speed when the crosshair moves between the plurality of subranges. This not only can assist the crosshair in quickly aiming at a virtual object, but also ensures smooth transition of the moving speed of the crosshair to achieve a natural effect of auxiliary aiming, and improves precision of aiming at a virtual object by the crosshair. The user does not need to perform repeated adjustment, so that adjustment efficiency is improved, and human-computer interaction efficiency is further improved.

In the embodiment shown in FIG. 3, an example in which the crosshair is located only within the attraction range of the first virtual object is used for description. However, in another embodiment, a plurality of virtual objects are displayed on the scene interface, and the crosshair may be located within attraction ranges of the plurality of virtual objects at the same time. In this case, the first virtual object further needs to be determined from the plurality of virtual objects. To be specific, a process of determining the first virtual object includes: when the crosshair is located within the attraction ranges of the plurality of virtual objects and the first moving direction points to the plurality of virtual objects, determining the first virtual object among the plurality of virtual objects that is closest to the second virtual object, the second virtual object being a virtual object controlled by the terminal.

In this embodiment of this application, because the attraction ranges of the plurality of virtual objects overlap, the crosshair being located within an overlapping area of the attraction ranges of the plurality of virtual objects is equivalent to the crosshair being located within the attraction ranges of the plurality of virtual objects. In addition, the plurality of virtual objects whose attraction ranges have the overlapping area may block each other. For example, for the second virtual object, a virtual object among the plurality of virtual objects that is closest to the second virtual object is not blocked by another virtual object among the plurality of virtual objects, and a virtual object among the plurality of virtual objects that is farthest away from the second virtual object may be blocked by another virtual object among the plurality of virtual objects. During interaction with a virtual object that the crosshair aims at, interaction is performed with a non-blocked virtual object if possible. Therefore, the first virtual object among the plurality of virtual objects that is closest to the second virtual object is used as a virtual object that the user may intend to aim at, so that the crosshair is subsequently controlled to move toward the first virtual object to aim at the first virtual object. This ensures accuracy of the determined first virtual object.

Based on the embodiments shown in FIG. 2 and FIG. 3, the crosshair may further move along with the first virtual object. To be specific, the method further includes: displaying the crosshair moving along with the first virtual object in response to the first virtual object moving in a direction away from the crosshair in the virtual environment.

In this embodiment of this application, in a process in which the crosshair moves toward the first virtual object to be attracted to the first virtual object, a virtual object in the virtual environment may move. In this case, the crosshair is controlled to move along with the first virtual object, so that the crosshair can be attracted to the first virtual object to aim at the first virtual object, to ensure aiming efficiency of the crosshair. The crosshair does not need to be manually controlled to aim at the first virtual object, so that human-computer interaction efficiency is improved.

In a possible implementation, a process of the crosshair moving along with the first virtual object includes: in response to the first virtual object moving in a direction away from the crosshair in the virtual environment, determining a fourth moving speed based on the third moving speed and a difference between a displacement of the first moving operation and a displacement of the first virtual object; and displaying, on the scene interface, the crosshair moving along with the first virtual object at the fourth moving speed.

In this embodiment of this application, in a process of controlling the crosshair to move toward the first virtual object in response to the first moving operation, the displacement of the first moving operation is mapped to the virtual environment, to obtain a displacement by which the crosshair moves toward the first virtual object. To be specific, the user triggers the first moving operation to control the crosshair to move toward the first virtual object, and a larger displacement of the first moving operation indicates that the crosshair is closer to the first virtual object. When the first virtual object moves in the direction away from the crosshair, the difference between the displacement of the first moving operation and the displacement of the first virtual object can indicate a change in a relative distance between the crosshair and the first virtual object. A larger difference indicates a larger relative distance between the crosshair and the first virtual object. In this case, the fourth moving speed is determined based on the difference and a current third moving speed of the crosshair, and the crosshair moving along with the first virtual object at the fourth moving speed is displayed, so that the relative distance between the crosshair and the first virtual object gradually decreases, and the crosshair can be attracted to the first virtual object as soon as possible to aim at the first virtual object. This ensures aiming efficiency of the crosshair, and further improves human-computer interaction efficiency.

In a process in which the first virtual object moves in the direction away from the crosshair, a moving speed of the crosshair is adjusted in real time based on the difference between the displacement of the first moving operation and the displacement of the first virtual object in the foregoing manner, so that the crosshair can move along with the first virtual object, to be attracted to the first virtual object as soon as possible.

Based on the embodiments shown in FIG. 2 and FIG. 3, in this embodiment of this application, the user can further control, through a moving operation, the crosshair to move in the direction away from the first virtual object. For a specific process, refer to the following embodiments.

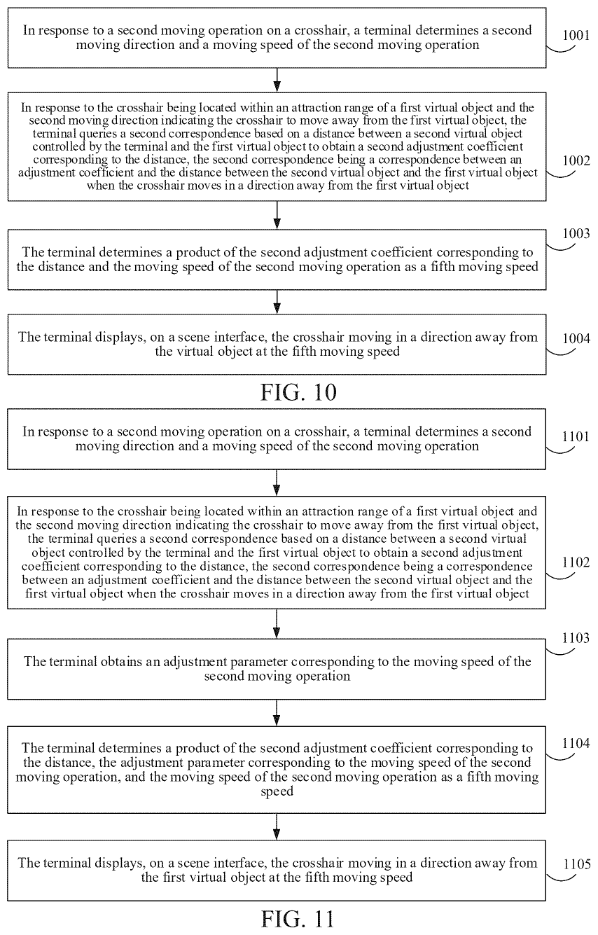

FIG. 10 is a flowchart of a crosshair control method according to an embodiment of this application. The method is performed by a terminal. As shown in FIG. 10, the method includes the following operations:

1001: In response to a second moving operation on a crosshair, the terminal determines a second moving direction and a moving speed of the second moving operation.

This operation is similar to operation 302. Details are not described herein again.

1002: In response to the crosshair being located within an attraction range of a first virtual object and the second moving direction indicating the crosshair to move away from the first virtual object, the terminal queries a second correspondence based on a distance between a second virtual object controlled by the terminal and the first virtual object to obtain a second adjustment coefficient corresponding to the distance, the second correspondence being a correspondence between an adjustment coefficient and the distance between the second virtual object and the first virtual object when the crosshair moves in a direction away from the first virtual object.

In this embodiment of this application, the first virtual object is referred to as a to-be-aimed-at target virtual object, the second correspondence is a correspondence applicable when the crosshair moves in a direction away from the target virtual object, and the second correspondence includes a distance and a corresponding adjustment coefficient. In this case, based on the distance between the second virtual object and the first virtual object, the second adjustment coefficient corresponding to the distance can be determined from the second correspondence, to ensure accuracy of the determined adjustment coefficient.

The second correspondence can be represented in any form. For example, the second correspondence is represented in a form of a line graph, an X axis in the line graph is configured for representing a distance, a Y axis in the line graph is configured for representing an adjustment parameter, and a curve in the line graph can represent an adjustment parameter corresponding to each distance. For example, the second correspondence is Auto Aim Away Scale By Dist.

In a possible implementation, the distance and the corresponding adjustment coefficient in the second correspondence are negatively correlated with each other.

For example, in the second correspondence, a larger distance corresponds to a smaller adjustment coefficient, and a shorter distance corresponds to a larger adjustment coefficient.

1003: The terminal determines a product of the second adjustment coefficient corresponding to the distance and the moving speed of the second moving operation as a fifth moving speed.

In this embodiment of this application, the second adjustment coefficient is equivalent to attraction strength of the crosshair moving away from the first virtual object. The product of the second adjustment coefficient and the moving speed of the second moving operation is used as the fifth moving speed, so that the attraction strength can be reflected when the crosshair subsequently moves away from the first virtual object at the fifth moving speed.

In this embodiment of this application, the second correspondence is a correspondence applicable when the crosshair moves in a direction away from the target virtual object. When the crosshair moves in a direction away from the first virtual object, the second correspondence is queried based on the distance between the second virtual object and the first virtual object, and a moving speed of the crosshair is adjusted based on the found second adjustment coefficient, so that the obtained fifth moving speed is related to the distance.

In a possible implementation, the adjustment coefficient in the second correspondence is less than 1.

In this embodiment of this application, the fifth moving speed obtained based on the second adjustment coefficient is less than the moving speed of the second moving operation, so that a moving speed of the crosshair moving in a direction away from the first virtual object is reduced as much as possible, to avoid a case in which the crosshair no longer aims at the first virtual object due to misoperation by a user, and ensure that the crosshair can aim at the virtual object if possible.

In this application, an example in which the product of the second adjustment coefficient and the second moving speed is used as the fifth moving speed is used for description. However, in another embodiment, operation 2 does not need to be performed, and the second moving speed is adjusted based on the second adjustment coefficient in another manner, to obtain the fifth moving speed.

1004: The terminal displays, on a scene interface, the crosshair moving in a direction away from the virtual object at the fifth moving speed.

In this embodiment of this application, the second correspondence is a correspondence applicable when the crosshair moves in a direction away from the target virtual object. When the crosshair moves in a direction away from the first virtual object, a moving speed of the crosshair is adjusted based on the second correspondence and the distance between the second virtual object and the first virtual object, so that the obtained fifth moving speed is related to the distance. In this way, the determined moving speed conforms to a case in which the crosshair is controlled to move away from the first virtual object when an auxiliary aiming function is triggered, to ensure that the determined moving speed matches a real intention of the user, and ensure accuracy of the determined fifth moving speed.

In addition, when the adjustment coefficient in the second correspondence is less than 1, the fifth moving speed obtained based on the second adjustment coefficient is less than the moving speed of the second moving operation, so that a moving speed of the crosshair moving in a direction away from the first virtual object is reduced as much as possible, to avoid a case in which the crosshair is detached from the aimed-at first virtual object due to misoperation by the user, and ensure that the crosshair can aim at the virtual object if possible.

Based on the embodiment shown in FIG. 10, the user can further determine a fourth moving speed based on an adjustment parameter corresponding to the moving speed of the second moving operation. For a specific process, refer to the following embodiment.

FIG. 11 is a flowchart of a crosshair control method according to an embodiment of this application. The method is performed by a terminal. As shown in FIG. 11, the method includes the following operations:

1101: In response to a second moving operation on a crosshair, the terminal determines a second moving direction and a moving speed of the second moving operation.

1102: In response to the crosshair being located within an attraction range of a first virtual object and the second moving direction indicating the crosshair to move away from the first virtual object, the terminal queries a second correspondence based on a distance between a second virtual object controlled by the terminal and the first virtual object to obtain a second adjustment coefficient corresponding to the distance, the second correspondence being a correspondence between an adjustment coefficient and the distance between the second virtual object and the first virtual object when the crosshair moves in a direction away from the first virtual object.

Operations 1101 and 1102 are similar to operations 1001 and 1002. Details are not described herein again.

1103: The terminal obtains an adjustment parameter corresponding to the moving speed of the second moving operation.

In this embodiment of this application, when the second moving operation is an operation of controlling the crosshair to move away from the first virtual object, the adjustment parameter corresponding to the moving speed of the second moving operation is further obtained. The adjustment parameter is configured for adjusting a moving speed of the crosshair moving away from the first virtual object.

In a possible implementation, operation 1103 includes: The terminal queries a fifth correspondence based on the moving speed of the second moving operation to obtain the adjustment parameter corresponding to the moving speed of the second moving operation.

The fifth correspondence is a correspondence between an adjustment parameter and a moving speed of a moving operation of controlling the crosshair to move away from the first virtual object when the crosshair moves away from the first virtual object. The fifth correspondence can be represented in any form. For example, the fifth correspondence is represented in a form of a line graph, an X axis in the line graph is configured for representing a moving speed, a Y axis in the line graph is configured for representing an adjustment parameter, and a curve in the line graph can represent an adjustment parameter corresponding to each moving speed. For example, the fifth correspondence is Lock Degress Factor Away Mid.

In a possible implementation, the second moving operation on the crosshair is a sliding operation performed by a user on a screen of the terminal, and operation 1103 includes: The terminal determines a sliding coefficient of the moving speed of the second moving operation, queries a sixth correspondence to obtain an adjustment parameter corresponding to the sliding coefficient, and determines the adjustment parameter corresponding to the sliding coefficient as the adjustment parameter corresponding to the moving speed of the second moving operation.

The sliding coefficient is configured for representing a case in which the second moving operation is triggered. The sixth correspondence is a correspondence between an adjustment parameter and a sliding coefficient corresponding to a moving operation of controlling the crosshair to move away from the first virtual object when the crosshair moves away from the first virtual object. The sixth correspondence can be represented in any form. For example, the sixth correspondence is represented in a form of a line graph, an X axis in the line graph is configured for representing a sliding coefficient, a Y axis in the line graph is configured for representing an adjustment parameter, and a curve in the line graph can represent an adjustment parameter corresponding to each sliding coefficient.

In a possible implementation, the moving speed of the second moving operation is represented by a rotation angle of a virtual camera in a virtual environment, and the rotation angle of the virtual camera includes a pitch and a yaw. In this case, a process of determining the sliding coefficient of the moving speed of the second moving operation includes: determining a larger one of the pitch and the yaw included in the rotation angle of the virtual camera as the sliding coefficient of the second moving operation.

In some embodiments, a process of obtaining the pitch and the yaw includes: The terminal extracts the pitch and the yaw from a rotation input cache.

In this embodiment of this application, the rotation input cache is configured to store a rotation angle inputted by the user.

In some embodiments, a process of determining the rotation angle of the virtual camera includes: In response to the sliding operation on the crosshair, the terminal determines a direction from a start point to an end point of the sliding operation as a rotation direction of the virtual camera in the virtual environment, determines a ratio of a distance between the start point and the end point to sliding duration as a sliding speed of the sliding operation, and maps the sliding speed of the sliding operation to the virtual environment to obtain the rotation angle of the virtual camera.

1104: The terminal determines a product of the second adjustment coefficient corresponding to the distance, the adjustment parameter corresponding to the moving speed of the second moving operation, and the moving speed of the second moving operation as a fifth moving speed.

This operation is similar to operation 1003. Details are not described herein again.

In this embodiment of this application, the fifth moving speed is determined based on the adjustment parameter corresponding to the moving speed of the second moving operation. However, in another embodiment, operations 1103 and 1104 do not need to be performed, and a product of the second adjustment coefficient corresponding to the distance and the moving speed of the second moving operation is determined as the fifth moving speed in another manner.

1105: The terminal displays, on a scene interface, the crosshair moving in a direction away from the first virtual object at the fifth moving speed.

In this embodiment of this application, the second correspondence is a correspondence applicable when the crosshair moves in a direction away from the target virtual object. When the crosshair moves in a direction away from the first virtual object, a mechanism in which the crosshair keeps aiming at the first virtual object is used, and a moving speed of the crosshair is adjusted based on the second correspondence and the distance between the second virtual object and the first virtual object and with reference to the adjustment parameter corresponding to the moving speed of the second moving operation, so that the obtained fifth moving speed is related to the distance and the moving speed of the second moving operation, to ensure accuracy of the determined fifth moving speed, avoid a case in which the crosshair is detached from the aimed-at first virtual object due to misoperation by the user, and ensure that the crosshair can aim at the virtual object if possible.

In addition, based on the foregoing embodiments, when the crosshair is located within the attraction range of the first virtual object and the auxiliary aiming function continuously takes effect, a moving speed of the crosshair is adjusted in the manner provided in the embodiments of this application, to make the crosshair aim at the first virtual object if possible. In addition, the user can further control the crosshair to move out of the attraction range of the first virtual object. After the crosshair moves out of the attraction range of the first virtual object, if duration in which the crosshair is located outside the attraction range is less than a duration threshold, the auxiliary aiming function continuously takes effect, and a moving speed of the crosshair is further adjusted based on the foregoing embodiments, to make the crosshair aim at the first virtual object if possible. However, if the duration in which the crosshair is located outside the attraction range is not less than the duration threshold, the auxiliary aiming function does not take effect, and a moving speed of the crosshair is no longer adjusted; instead, a moving speed of a moving operation on the crosshair is mapped to the virtual environment, and the crosshair moving along a moving direction of the moving operation at a moving speed obtained through mapping is displayed.

In addition, in the crosshair control method provided in the embodiments of this application, the terminal displays video frames frame by frame in a form of video frames of a game, to display a game picture on a scene interface. In the foregoing embodiments, in a process of controlling the crosshair to move in response to a moving operation on the crosshair, a time interval at which the terminal displays a video frame of the game may be used as a unit. The crosshair is controlled at the time interval according to the crosshair control method provided in the embodiments of this application, so that a position to which the crosshair moves is displayed in a next video frame. Further, in a process of continuously displaying a plurality of video frames of the game, the terminal displays a picture of the crosshair moving toward the first virtual object. A time interval between two adjacent video frames is any duration. For example, the time interval is 0.3 seconds or 0.2 seconds. In the embodiments of this application, the first moving operation triggered by the user may correspond to a plurality of time intervals. In this case, in response to the first moving operation, based on a currently displayed video frame and the embodiments shown in FIG. 2 to FIG. 11, the second moving speed of the crosshair is determined, a display position of the crosshair in a next video frame is determined, and then the next video frame is displayed. The foregoing operations are repeated. In a process of continuously displaying a plurality of video frames of the game, the terminal displays a picture of the crosshair moving toward the first virtual object.

In the embodiments of this application, based on the foregoing embodiments, a process of controlling the crosshair to move toward the first virtual object in response to a moving operation on the crosshair belongs to active attraction logic. To be specific, the active attraction logic means that a user actively controls the crosshair to be attracted to a virtual object. In addition, the embodiments of this application further provide passive attraction logic, to be specific, attraction logic that is not based on an aiming operation actively enabled by a user. When the crosshair is located within the attraction range of the first virtual object, passive attraction logic of the crosshair is triggered. The passive attraction logic does not rely on a moving operation triggered by the user on the crosshair. When the user triggers no moving operation on the crosshair, the passive attraction logic of the crosshair may be triggered provided that the crosshair is located within the attraction range of the first virtual object. A process of attracting the crosshair to the first virtual object when the passive attraction logic is triggered is similar to the foregoing process of attracting the crosshair to the first virtual object when the user triggers the active attraction logic. Details are not described herein again. In the active attraction logic and the passive attraction logic, aiming speeds are configured in both a firing state and a non-firing state, in other words, moving speeds are configured for the crosshair in both the firing state and the non-firing state, for example, Passive Auto Aim Speed (a passive attraction and aiming speed in the non-firing state), Passive Auto Aim Fire Speed (a passive attraction and aiming speed in the firing state), Auto Aim Speed (an active attraction and aiming speed in the non-firing state), and Auto Aim Fire Speed (an active attraction and aiming speed in the firing state). In addition, in the firing state, the crosshair is attracted to an attraction point on the first virtual object according to the active attraction logic. After a period of time, the active attraction logic is turned off. In this case, the crosshair has already aimed at the first virtual object, and the active attraction logic does not need to be triggered again. The period of time may be any duration, for example, 5 seconds, or duration required for the second virtual object to launch any quantity of items based on a held virtual item.

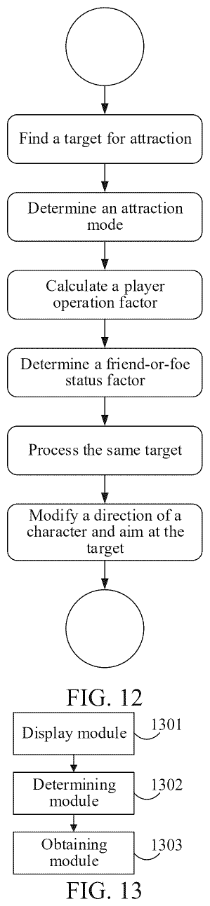

Based on the embodiments shown in FIG. 2 to FIG. 11, the embodiments of this application further provide a flowchart of a crosshair control method. As shown in FIG. 12, the method includes the following operations:

Operation 1: A user triggers a moving operation on a crosshair by using a terminal, to control the crosshair to move in a virtual environment to search for a to-be-aimed-at virtual object. When the crosshair is located within attraction ranges of a plurality of virtual objects, a first virtual object among the plurality of virtual objects that is closest to a second virtual object controlled by the user by using the terminal is selected as a to-be-aimed-at virtual object through ray detection.

In this embodiment of this application, the first virtual object closest to the second virtual object controlled by the user by using the terminal is preferentially used as a to-be-aimed-at virtual object according to an auto aim order.

Operation 2: The terminal determines an attraction mode, and determines whether to perform active attraction or passive attraction.

Operation 3: The terminal calculates a user operation factor; determines, based on the moving operation triggered by the user, whether the crosshair is to approach the first virtual object or move away from the first virtual object; determines a first attraction point from an auxiliary aiming line based on a moving direction indicated by the moving operation, to determine whether to aim at a head or a torso of the first virtual object; and when the crosshair is to approach or move away from the first virtual object, determines a moving speed of the crosshair based on a moving speed of the moving operation in the manner provided in the foregoing embodiments.

Operation 4: The terminal determines a friend-or-foe status factor, to be specific, determines whether a virtual item held by the second virtual object fires, a moving speed of the second virtual object, whether the second virtual object uses a skill buff, and the like.

Operation 5: The terminal displays, on a scene interface, the crosshair moving toward the first attraction point of the first virtual object at the determined moving speed, so that the crosshair is attracted to the first attraction point to aim at the first virtual object.

Operation 6: In a process in which the crosshair moves toward the first virtual object to aim at the first virtual object, when the first virtual object moves, the terminal displays the crosshair automatically moving along with the first virtual object, and when the crosshair moves between a plurality of subranges included in an attraction range of the first virtual object, the terminal can determine a new attraction point for the crosshair, and control a moving speed of the crosshair, to achieve smooth transition of the moving speed of the crosshair when the crosshair moves between the plurality of subranges.

FIG. 13 is a schematic diagram of a structure of a crosshair control apparatus according to an embodiment of this application. As shown in FIG. 13, the apparatus includes:
a display module 1301, configured to display a scene interface of a virtual environment, a first virtual object and a crosshair being displayed on the scene interface;
a determining module 1302, configured to: when the crosshair is located outside an attraction range of the first virtual object, determine, in response to a first moving operation on the crosshair, a first moving direction of the crosshair that is indicated by the first moving operation; and
an obtaining module 1303, configured to determine a first attraction point on the first virtual object based on a motion posture of the first virtual object when the crosshair is located within the attraction range of the first virtual object and the first moving direction points to the first virtual object,
the display module 1301 being further configured to display, on the scene interface, the crosshair moving toward the first attraction point.

In a possible implementation, the obtaining module 1303 is configured to: determine, based on the motion posture of the first virtual object, an auxiliary aiming line of the first virtual object; and determine the first attraction point from the auxiliary aiming line of the first virtual object.

In another possible implementation, the obtaining module 1303 is configured to: determine positions of key points on the first virtual object when the first virtual object is in the motion posture; and connect the key points based on the positions of the key points to form the auxiliary aiming line.

In another possible implementation, the obtaining module 1303 is configured to: determine the first attraction point based on an intersection point between a ray along the first moving direction and the auxiliary aiming line, a current position of the crosshair being a start point of the ray; or determine the first attraction point based on a point that is on the auxiliary aiming line and that is on a same horizontal line as the crosshair; or determine a point that is on the auxiliary aiming line and that has a shortest distance from the crosshair as the first attraction point.

In another possible implementation, the auxiliary aiming line includes a first line segment, a second line segment, and a third line segment, the first line segment is a line segment between a head key point of the first virtual object and the upper boundary of the attraction range, the second line segment is a line segment between a torso key point of the first virtual object and the lower boundary of the attraction range, and the third line segment is a line segment between the head key point and the torso key point; and the determining module 1302 is configured to: when the intersection point is an intersection point between the ray and the first line segment, determine the head key point as the first attraction point; or when the intersection point is an intersection point between the ray and the second line segment, determine the torso key point as the first attraction point; or when the intersection point is an intersection point between the ray and the third line segment, determine the intersection point between the ray and the third line segment as the first attraction point.

In another possible implementation, the auxiliary aiming line includes a first line segment, a second line segment, and a third line segment, the first line segment is a line segment between a head key point of the first virtual object and the upper boundary of the attraction range, the second line segment is a line segment between a torso key point of the first virtual object and the lower boundary of the attraction range, and the third line segment is a line segment between the head key point and the torso key point; and the determining module 1302 is configured to: when the crosshair and a point in the first line segment are located on a same horizontal line, determine the head key point as the first attraction point; or when the crosshair and a point in the second line segment are located on a same horizontal line, determine the torso key point as the first attraction point; or when the crosshair and a point in the third line segment are located on a same horizontal line, determine, as the first attraction point, the point that is in the third line segment and that is located on the same horizontal line as the crosshair.

In another possible implementation, the attraction range includes a plurality of subranges, and the first attraction point is located within a first subrange of the plurality of subranges;
the determining module 1302 is further configured to: in response to the crosshair entering a second subrange from the first subrange, determine, from the auxiliary aiming line, a second attraction point located within the second subrange, the second subrange being a subrange adjacent to the first subrange among the plurality of subranges;
the obtaining module 1303 is further configured to determine a fifth moving speed based on existence duration of the crosshair within the second subrange and a current moving speed of the crosshair; and
the display module 1301 is further configured to display, on the scene interface, the crosshair moving toward the second attraction point at the fifth moving speed.

In another possible implementation, the obtaining module 1303 is further configured to determine a third moving speed based on a second moving speed and a distance between a second virtual object controlled by the terminal and the first virtual object, the second moving speed being a moving speed of the first moving operation, and the third moving speed being negatively correlated with the distance; and
the display module 1301 is configured to display, on the scene interface, the crosshair moving toward the first attraction point at the third moving speed.

In a possible implementation, the obtaining module 1303 is configured to determine the third moving speed based on the second moving speed and the distance between the second virtual object and the first virtual object when the second moving speed is greater than the preset speed threshold.

In another possible implementation, the obtaining module 1303 is configured to: query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object; and determine a product of the second moving speed and the first adjustment coefficient corresponding to the distance as the third moving speed.

In another possible implementation, the crosshair is displayed when the second virtual object holds a virtual item; and the obtaining module 1303 is configured to: query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object; obtain an adjustment coefficient corresponding to the virtual item; and determine a product of the adjustment coefficient corresponding to the virtual item, the first adjustment coefficient corresponding to the distance, and the second moving speed as the third moving speed.

In another possible implementation, the obtaining module 1303 is configured to: query a first correspondence based on the distance between the second virtual object and the first virtual object to obtain a first adjustment coefficient corresponding to the distance, the first correspondence being a correspondence between an adjustment coefficient and the distance between the second virtual object and the first virtual object when the crosshair moves toward the first virtual object; obtain a scaling ratio, the scaling ratio being configured for mapping the second moving speed of the first moving operation to the virtual environment; and determine a product of the first adjustment coefficient corresponding to the distance, the scaling ratio, and the second moving speed as the third moving speed.

In another possible implementation, a plurality of virtual objects are displayed on the scene interface; and the obtaining module 1303 is configured to: when the crosshair is located within the attraction ranges of the plurality of virtual objects and the first moving direction points to the plurality of virtual objects, determine the first virtual object among the plurality of virtual objects that is closest to the second virtual object, the second virtual object being a virtual object controlled by the terminal; and determine the first attraction point on the first virtual object based on the motion posture of the first virtual object.

In another possible implementation, the display module 1301 is further configured to display the crosshair moving along with the first virtual object in response to the first virtual object moving in a direction away from the crosshair in the virtual environment.

In another possible implementation, the display module 1301 is configured to: in response to the first virtual object moving in a direction away from the crosshair in the virtual environment, determine a fourth moving speed based on the third moving speed and a difference between a displacement of the first moving operation and a displacement of the first virtual object, the third moving speed being a speed at which the crosshair moves toward the first attraction point; and display, on the scene interface, the crosshair moving along with the first virtual object at the fourth moving speed.

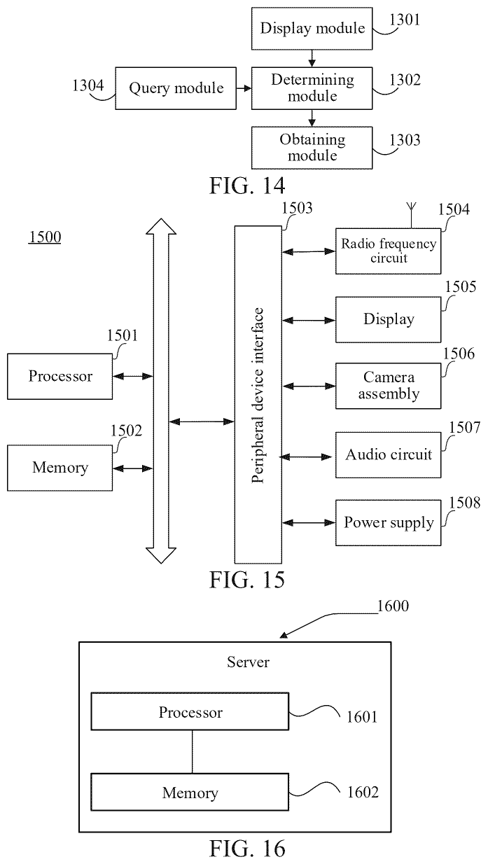

In another possible implementation, as shown in FIG. 14, the apparatus further includes:
the determining module 1302 is further configured to: in response to a second moving operation on the crosshair, determine a second moving direction and a moving speed of the second moving operation;
a query module 1304 is configured to: in response to the crosshair being located within the attraction range of the first virtual object and the second moving direction indicating the crosshair to move away from the first virtual object, query a second correspondence based on the distance between the second virtual object controlled by the terminal and the first virtual object to obtain a second adjustment coefficient corresponding to the distance, the second correspondence being a correspondence between an adjustment coefficient and the distance between the second virtual object and the first virtual object when the crosshair moves in a direction away from the first virtual object;
the determining module 1302 is further configured to determine a product of the second adjustment coefficient corresponding to the distance and the moving speed of the second moving operation as the fifth moving speed; and
the display module 1301 is further configured to display, on the scene interface, the crosshair moving in a direction away from the first virtual object at the fifth moving speed.

In another possible implementation, the obtaining module 1303 is further configured to obtain an adjustment parameter corresponding to the moving speed of the second moving operation; and
the determining module 1302 is configured to determine a product of the second adjustment coefficient corresponding to the distance, the adjustment parameter corresponding to the moving speed of the second moving operation, and the moving speed of the second moving operation as the fifth moving speed.

The crosshair control apparatus provided in the foregoing embodiments is described by using division of the foregoing functional modules as an example. During actual application, the foregoing functions may be allocated to and completed by different functional modules as needed. To be specific, an internal structure of a computer device is divided into different functional modules to implement all or some of the functions described above. In addition, the crosshair control apparatus provided in the foregoing embodiments and the crosshair control method embodiments belong to a same concept. For details about a specific implementation process of the crosshair control apparatus, refer to the method embodiments. Details are not described herein again.

The embodiments of this application further provide a computer device. The computer device includes a processor and a memory. The memory has at least one computer program stored therein. The at least one computer program is loaded and executed by the processor to implement the operations performed in the crosshair control method in the foregoing embodiments.

In some embodiments, the computer device is provided as a terminal. FIG. 15 is a block diagram of a structure of a terminal 1500 according to an exemplary embodiment of this application. The terminal 1500 includes a processor 1501 and a memory 1502.

The processor 1501 may include one or more processing cores, for example, a 4-core processor or an 8-core processor. The processor 1501 may be implemented in at least one hardware form of a digital signal processor (DSP), a field programmable gate array (FPGA), or a programmable logic array (PLA). The processor 1501 may alternatively include a main processor and a coprocessor. The main processor is a processor configured to process data in an awake state, and is also referred to as a central processing unit (CPU). The coprocessor is a low-power processor configured to process data in a standby state. In some embodiments, the processor 1501 may be integrated with a graphics processing unit (GPU). The GPU is configured to render and draw content that needs to be displayed on a display. In some embodiments, the processor 1501 may further include an AI processor. The AI processor is configured to process computing operations related to machine learning.

The memory 1502 may include one or more non-transitory computer-readable storage media. The computer-readable storage medium may be non-transitory. The memory 1502 may further include a high-speed random access memory and a nonvolatile memory, for example, one or more disk storage devices or flash storage devices. In some embodiments, the non-transitory computer-readable storage medium in the memory 1502 is configured to store at least one computer program. The at least one computer program is configured for being executed by the processor 1501 to implement the crosshair control method provided in the method embodiments of this application.

In some embodiments, the terminal 1500 further includes a peripheral device interface 1503 and at least one peripheral device. The processor 1501, the memory 1502, and the peripheral device interface 1503 may be connected through a bus or a signal cable. Each peripheral device may be connected to the peripheral device interface 1503 through a bus, a signal cable, or a circuit board. Specifically, the peripheral device includes at least one of a radio frequency (RF) circuit 1504, a display 1505, a camera assembly 1506, an audio circuit 1507, and a power supply 1508.

The peripheral device interface 1503 may be configured to connect the at least one peripheral device related to input/output (I/O) to the processor 1501 and the memory 1502. In some embodiments, the processor 1501, the memory 1502, and the peripheral device interface 1503 are integrated on a same chip or circuit board. In some other embodiments, any one or two of the processor 1501, the memory 1502, and the peripheral device interface 1503 may be implemented on a separate chip or circuit board. This is not limited in this embodiment.

The RF circuit 1504 is configured to receive and transmit an RF signal, which is also referred to as an electromagnetic signal. The RF circuit 1504 communicates with a communication network and another communication device through the electromagnetic signal. The RF circuit 1504 converts an electrical signal into an electromagnetic signal for transmission, or converts a received electromagnetic signal into an electrical signal. In some embodiments, the RF circuit 1504 includes an antenna system, an RF transceiver, one or more amplifiers, a tuner, an oscillator, a DSP, a codec chipset, a subscriber identity module card, and the like. The RF circuit 1504 may communicate with another terminal through at least one wireless communication protocol. The wireless communication protocol includes but is not limited to the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 1504 may further include a circuit related to near field communication (NFC). This is not limited in this application.

The display 1505 is configured to display a user interface (UI). The UI may include a graph, text, an icon, a video, and any combination thereof. When the display 1505 is a touch display, the display 1505 further has a capability of capturing a touch signal on or above a surface of the display 1505. The touch signal may be inputted to the processor 1501 as a control signal for processing. In this case, the display 1505 may be further configured to provide a virtual button and/or a virtual keyboard, which are/is also referred to as a soft button and/or a soft keyboard. In some embodiments, there may be one display 1505, which is arranged on a front panel of the terminal 1500. In some other embodiments, there may be at least two displays 1505, which are respectively arranged on different surfaces of the terminal 1500 or designed in a folded form. In some other embodiments, the display 1505 may be a flexible display arranged on a curved surface or a folded surface of the terminal 1500. Alternatively, the display 1505 may be even arranged in a non-rectangular irregular pattern, namely, a special-shaped screen. The display 1505 may be made of a liquid crystal display (LCD), an organic light-emitting diode (OLED), or other materials.

The camera assembly 1506 is configured to capture images or videos. In some embodiments, the camera assembly 1506 includes a front-facing camera and a rear-facing camera. The front-facing camera is arranged on the front panel of the terminal, and the rear-facing camera is arranged on a rear side of the terminal. In some embodiments, there are at least two rear-facing cameras, and each rear-facing camera is any one of a main camera, a depth-of-field camera, a wide-angle camera, and a telephoto camera, to implement a background blur function through fusion of the main camera and the depth-of-field camera, and implement a panoramic photographing function and a virtual reality (VR) photographing function or other fusion photographing functions through fusion of the main camera and the wide-angle camera. In some embodiments, the camera assembly 1506 may further include a flash. The flash may be a mono color temperature flash or a double color temperature flash. The double color temperature flash is a combination of a warm light flash and a cold light flash, and may be used for light compensation under different color temperatures.

The audio circuit 1507 may include a microphone and a speaker. The microphone is configured to capture sound waves of a user and an environment, convert the sound waves into an electrical signal, and input the electrical signal to the processor 1501 for processing, or input the electrical signal to the RF circuit 1504 to implement voice communication. To capture stereo or reduce noise, there may be a plurality of microphones, which are respectively disposed at different portions of the terminal 1500. The microphone may alternatively be an array microphone or an omni-directional capture microphone. The speaker is configured to convert an electrical signal from the processor 1501 or the RF circuit 1504 into a sound wave. The speaker may be a conventional film speaker or a piezoelectric ceramic speaker. When the speaker is a piezoelectric ceramic speaker, the speaker not only can convert an electrical signal into a sound wave audible to a human being, but also can convert an electrical signal into a sound wave inaudible to a human being, for ranging and other purposes. In some embodiments, the audio circuit 1507 may further include a headset jack.

The power supply 1508 is configured to supply power to components in the terminal 1500. The power supply 1508 may be an alternating current power supply, a direct current power supply, a disposable battery, or a rechargeable battery. When the power supply 1508 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

A person skilled in the art may understand that the structure shown in FIG. 15 constitutes no limitation on the terminal 1500, and the terminal may include more or fewer components than those shown in the figure, or some components may be combined, or different component layouts may be used.

In some embodiments, the computer device is provided as a server. FIG. 16 is a schematic diagram of a structure of a server according to an embodiment of this application. The server 1600 may vary greatly due to different configurations or performance, and may include one or more CPUs 1601 and one or more memories 1602. The memory 1602 has at least one computer program stored therein. The at least one computer program is loaded and executed by the processor 1601 to implement the methods provided in the foregoing method embodiments. Certainly, the server may further include components such as a wired or wireless network interface, a keyboard, and an I/O interface for input and output. The server may further include another component for implementing a device function. Details are not described herein.

The embodiments of this application further provide a computer-readable storage medium. The computer-readable storage medium has at least one computer program stored therein. The at least one computer program is loaded and executed by a processor to implement the operations performed in the crosshair control method in the foregoing embodiments.

The embodiments of this application further provide a computer program product, including a computer program. When the computer program is executed by a processor, the operations performed in the crosshair control method in the foregoing embodiments are implemented.

Technical features in the foregoing embodiments may be combined in different manners. To make description concise, not all possible combinations of the technical features in the foregoing embodiments are described. However, all combinations of these technical features shall be considered as falling within the scope recorded in this specification provided that no conflict exists.

In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing embodiments only describe several implementations of this application specifically and in detail, but cannot be construed as a limitation to the patent scope of this application. A person of ordinary skill in the art may also make several variations and improvements without departing from the concept of this application. All these variations and improvements fall within the protection scope of this application. Therefore, the protection scope of the patent of this application shall be subject to the appended claims.

What is claimed is:

1. A crosshair control method performed by a computer device, the method comprising:
displaying a first virtual object and a crosshair on a scene interface of a virtual environment;
when the crosshair is located outside an attraction range of the first virtual object, determining a first moving direction of the crosshair in response to a first moving operation on the crosshair by a user of the computer device;
determining a first attraction point on the first virtual object based on a motion posture of the first virtual object in response to the crosshair being located within the attraction range and the first moving direction pointing to the first virtual object; and
moving the crosshair toward the first attraction point on the scene interface.

2. The method according to claim 1, wherein the determining a first attraction point on the first virtual object based on a motion posture of the first virtual object comprises:
determining an auxiliary aiming line of the first virtual object based on the motion posture of the first virtual object; and
determining the first attraction point from the auxiliary aiming line of the first virtual object.

3. The method according to claim 2, wherein the determining an auxiliary aiming line of the first virtual object based on the motion posture of the first virtual object comprises:
determining positions of key points on the first virtual object when the first virtual object is in the motion posture; and
connecting the key points based on the positions of the key points to form the auxiliary aiming line.

4. The method according to claim 2, wherein the determining the first attraction point from the auxiliary aiming line of the first virtual object comprises:
determining the first attraction point based on an intersection point between a ray along the first moving direction and the auxiliary aiming line, a current position of the crosshair being a start point of the ray.

5. The method according to claim 2, wherein the determining the first attraction point from the auxiliary aiming line of the first virtual object comprises:
determining the first attraction point based on a point that is on the auxiliary aiming line and that is on a same horizontal line as the crosshair.

6. The method according to claim 2, wherein the determining the first attraction point from the auxiliary aiming line of the first virtual object comprises:
determining a point that is on the auxiliary aiming line and that has a shortest distance from the crosshair as the first attraction point.

7. The method according to claim 2, wherein the attraction range comprises a first subrange and a second subrange adjacent to the first subrange and the first attraction point is located within the first subrange, and the method further comprises:
in response to the crosshair entering the second subrange from the first subrange, determining, from the auxiliary aiming line, a second attraction point located within the second subrange;
determining a first moving speed based on existence duration of the crosshair within the second subrange and a current moving speed of the crosshair; and
moving the crosshair toward the second attraction point on the scene interface at the first moving speed.

8. The method according to claim 1, wherein the method further comprises:
determining a second virtual object controlled by the user of the computer device;
determining a third moving speed based on a second moving speed of the first moving operation and a distance between the second virtual object and the first virtual object; and
moving the crosshair toward the first attraction point on the scene interface at the third moving speed.

9. The method according to claim 8, wherein the third moving speed is negatively correlated to the distance between the second virtual object and the first virtual object.

10. The method according to claim 1, wherein a plurality of virtual objects are displayed on the scene interface; and the determining the first attraction point on the first virtual object based on the motion posture of the first virtual object comprises:
in response to the crosshair being located within the attraction range and the first moving direction pointing to the plurality of virtual objects, determining the first virtual object among the plurality of virtual objects that is closest to the second virtual object, the second virtual object being a virtual object controlled by the terminal; and
determining the first attraction point on the first virtual object based on the motion posture of the first virtual object.

11. The method according to claim 1, wherein the method further comprises:
moving the crosshair along with the first virtual object in response to the first virtual object moving in a direction away from the crosshair in the virtual environment.

12. The method according to claim 1, wherein the method further comprises:
in response to a second moving operation on the crosshair by the user of the computer device, determining a second moving direction and a moving speed of the second moving operation;
in response to the crosshair being located within the attraction range of the first virtual object and the second moving direction indicating the crosshair to move away from the first virtual object, querying a second correspondence based on a distance between the second virtual object and the first virtual object to obtain a second adjustment coefficient corresponding to the distance;
determining a fifth moving speed based on a product of the second adjustment coefficient corresponding to the distance and the moving speed of the second moving operation; and
moving the crosshair moving in a direction away from the first virtual object on the scene interface at the fifth moving speed.

13. A computer device, the computer device comprising a processor and a memory, the memory having at least one computer program stored therein, and the at least one computer program, when executed by the processor, causing the computer device to implement a crosshair control method including:
displaying a first virtual object and a crosshair on a scene interface of a virtual environment;
when the crosshair is located outside an attraction range of the first virtual object, determining a first moving direction of the crosshair in response to a first moving operation on the crosshair by a user of the computer device;
determining a first attraction point on the first virtual object based on a motion posture of the first virtual object in response to the crosshair being located within the attraction range and the first moving direction pointing to the first virtual object; and
moving the crosshair toward the first attraction point on the scene interface.

14. The computer device according to claim 13, wherein the determining a first attraction point on the first virtual object based on a motion posture of the first virtual object comprises:
determining an auxiliary aiming line of the first virtual object based on the motion posture of the first virtual object; and
determining the first attraction point from the auxiliary aiming line of the first virtual object.

15. The computer device according to claim 14, wherein the determining an auxiliary aiming line of the first virtual object based on the motion posture of the first virtual object comprises:
determining positions of key points on the first virtual object when the first virtual object is in the motion posture; and
connecting the key points based on the positions of the key points to form the auxiliary aiming line.

16. The computer device according to claim 13, wherein the attraction range comprises a first subrange and a second subrange adjacent to the first subrange and the first attraction point is located within the first subrange, and the method further comprises:
in response to the crosshair entering the second subrange from the first subrange, determining, from the auxiliary aiming line, a second attraction point located within the second subrange;
determining a first moving speed based on existence duration of the crosshair within the second subrange and a current moving speed of the crosshair; and
moving the crosshair toward the second attraction point on the scene interface at the first moving speed.

17. The computer device according to claim 13, wherein the method further comprises:
determining a second virtual object controlled by the user of the computer device;
determining a third moving speed based on a second moving speed of the first moving operation and a distance between the second virtual object and the first virtual object; and
moving the crosshair toward the first attraction point on the scene interface at the third moving speed.

18. The computer device according to claim 13, wherein a plurality of virtual objects are displayed on the scene interface; and the determining the first attraction point on the first virtual object based on the motion posture of the first virtual object comprises:
in response to the crosshair being located within the attraction range and the first moving direction pointing to the plurality of virtual objects, determining the first virtual object among the plurality of virtual objects that is closest to the second virtual object, the second virtual object being a virtual object controlled by the terminal; and
determining the first attraction point on the first virtual object based on the motion posture of the first virtual object.

19. The computer device according to claim 13, wherein the method further comprises:
moving the crosshair along with the first virtual object in response to the first virtual object moving in a direction away from the crosshair in the virtual environment.

20. A non-transitory computer-readable storage medium having at least one computer program stored therein, the at least one computer program, when executed by a processor of a computer device, causing the computer device to implement a crosshair control method including:
displaying a first virtual object and a crosshair on a scene interface of a virtual environment;
when the crosshair is located outside an attraction range of the first virtual object, determining a first moving direction of the crosshair in response to a first moving operation on the crosshair by a user of the computer device;
determining a first attraction point on the first virtual object based on a motion posture of the first virtual object in response to the crosshair being located within the attraction range and the first moving direction pointing to the first virtual object; and
moving the crosshair toward the first attraction point on the scene interface.
